(19) United States
(12) Patent Application Publication
(10) Pub. No.: US 2025/0030954 A1
(43) Pub. Date: Jan. 23, 2025

(54) SPATIALLY-ADAPTIVE BINNING AND REMOSAICING

(71) Applicant: QUALCOMM Incorporated, San Diego, CA (US)

(72) Inventors: Kai He, San Diego, CA (US); Hau Hwang, San Diego, CA (US); Meng-Lin Wu, San Diego, CA (US)

(21) Appl. No.: 18/353,650

(22) Filed: Jul. 17, 2023

(51) Int. Cl. H04N 25/46; H04N 19/167

(52) U.S. Cl. CPC H04N 25/46; H04N 19/167

(57) ABSTRACT

This disclosure provides systems, methods, and devices for image signal processing that support spatially-adaptive binning and remosaicing of image data. In a first aspect, a method of image processing includes receiving image data comprising at least a portion of an image frame. A first portion of the image data is coded according to a first binning pattern, and a second portion of the image data is coded according to a second binning pattern different from the first binning pattern. Other aspects and features are also claimed and described.

### TECHNICAL FIELD

Aspects of the present disclosure relate generally to image processing, and more particularly, to data compression for image processing. Some features may enable and provide improved image processing, including improved pixel binning for more efficient image processing with reduced computation.

### INTRODUCTION

Image capture devices are devices that can capture one or more digital images, whether still images for photos or sequences of images for videos. Capture devices can be incorporated into a wide variety of devices. By way of example, image capture devices may comprise stand-alone digital cameras or digital video camcorders, camera-equipped wireless communication device handsets, such as mobile telephones, cellular or satellite radio telephones, personal digital assistants (PDAs), panels or tablets, gaming devices, computing devices such as webcams, video surveillance cameras, or other devices with digital imaging or video capabilities.

The amount of image data captured by an image sensor has increased through subsequent generations of image capture devices. The amount of information captured by an image sensor is related to a number of pixels in an image sensor of the image capture device, which may be measured as a number of megapixels indicating the number of millions of sensors in the image sensor. For example, a 12-megapixel image sensor has 12 million pixels. Higher megapixel values generally represent higher resolution images that are more desirable for viewing by the user.

The increasing amount of image data captured by the image capture device has some negative effects that accompany the increasing resolution obtained by the additional image data. Additional image data increases the amount of processing performed by the image capture device in determining image frames and videos from the image data, as well as in performing other operations related to the image data. For example, the image data may be processed through several processing blocks for enhancing the image before the image data is displayed to a user on a display or transmitted to a recipient in a message. Each of the processing blocks consumes additional power and memory proportional to the amount of image data, or number of megapixels, in the image capture. The additional power consumption may shorten the operating time of an image capture device using battery power, such as a mobile phone.

### BRIEF SUMMARY OF SOME EXAMPLES

The following summarizes some aspects of the present disclosure to provide a basic understanding of the discussed technology. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

One cause for the shortened battery life of mobile devices operating as image capture devices is power consumed by transmitting data through data buses. Larger, higher-resolution image sensors capture larger amounts of data. The larger amounts of data are transmitted through data buses, in which the transmission of each bit consumes power. Power consumption may be reduced by compressing or subsampling image data captured by a camera of such a mobile device before transmission over a data bus, which reduces the amount of data transmitted over the data bus.

Pixel binning is one technique for reducing the amount of image data captured by a sensor by binning groups of adjacent pixels into single pixels. For example, an array of four pixels may be combined into one larger pixel using a two-by-two pixel binning pattern, which reduces the number of pixels from four to one and reduces the image resolution by half in each of the horizontal and vertical dimensions. Conventional pixel-binning techniques support only fixed binning patterns for an image. Higher pixel-binning increases memory and power savings, but results in a loss of image quality. Consequently, such techniques may cause image resolution to be substantially reduced as a compromise for lowering power consumption and memory requirements.

In some aspects, spatially-adaptive binning of image data is disclosed, which can reduce the amount of data transmitted through components of a mobile device as part of an image capture operation or image processing operation. The binned image data may include binned pixels of an image, in which at least one of a size, an aspect ratio, or a resolution of the pixels corresponding to different regions of the image may spatially vary across the image. A spatially-adaptive binning pattern may be applied to the pixels corresponding to each of the image regions with binning guidance that defines areas of interest in which the visual details are to be preserved. This allows the spatially-adaptive binning pattern to be applied for reducing the size of the image data without sacrificing image quality in the areas of interest or noise performance in other, low-light areas of the image.

The use of binned image data with spatially-varying binning patterns may reduce an amount of data transmitted over a data bus within the image capture device while preserving image quality in important portions of the image. The binned image data may be transmitted between an image sensor and an image signal processor, between an image sensor and a memory, between an image signal processor and a memory, between an image signal processor and a display, between an image signal processor and a central processing unit (CPU), between an image sensor and a display, or between other components of a mobile device. Each time the data is transmitted, power may be saved by the reduced size of the binned image data. Further, power consumption may be reduced by reducing the amount of data to be processed in image processing, including reducing an amount of data for autofocus or other operations.

In one aspect of the disclosure, a method includes receiving image data comprising at least a portion of an image frame; coding a first portion of the image data according to a first binning pattern; and coding a second portion of the image data according to a second binning pattern different from the first binning pattern.

In an additional aspect of the disclosure, an apparatus includes at least one processor and a memory coupled to the at least one processor. The at least one processor is configured to perform operations including receiving image data comprising at least a portion of an image frame; coding a first portion of the image data according to a first binning size; and coding a second portion of the image data according to a second binning size different from the first binning size.

In an additional aspect of the disclosure, a non-transitory computer-readable medium stores instructions that, when executed by a processor, cause the processor to perform operations. The operations include receiving image data comprising at least a portion of an image frame; coding a first portion of the image data according to a first binning size; and coding a second portion of the image data according to a second binning size different from the first binning size.

In an additional aspect of the disclosure, an image capture device includes an image sensor comprising a binning module to output image data comprising at least a portion of an image frame and to output metadata indicating a first binning size for a first portion of the image data and a second binning size for a second portion of the image data; a memory storing processor-readable code; and at least one processor coupled to the memory and to the image sensor. The at least one processor is configured to execute the processor-readable code to cause the at least one processor to perform operations including: receiving, from the image sensor over a data bus, the image data and the metadata; decoding the first portion to determine first decoded data based on the first binning size; decoding the second portion to determine second decoded data based on the second binning size; and determining the image frame by processing the first decoded data and the second decoded data.

Methods of image processing described herein may be performed by an image capture device and/or performed on image data captured by one or more image capture devices. Image capture devices, devices that can capture one or more digital images, whether still image photos or sequences of images for videos, can be incorporated into a wide variety of devices. By way of example, image capture devices may comprise stand-alone digital cameras or digital video camcorders, camera-equipped wireless communication device handsets, such as mobile telephones, cellular or satellite radio telephones, personal digital assistants (PDAs), panels or tablets, gaming devices, computing devices such as webcams, video surveillance cameras, or other devices with digital imaging or video capabilities.

The image processing techniques described herein may involve digital cameras having image sensors and processing circuitry (e.g., application specific integrated circuits (ASICs), digital signal processors (DSP), graphics processing unit (GPU), or central processing units (CPU)). An image signal processor (ISP) may include one or more of these processing circuits and configured to perform operations to obtain the image data for processing according to the image processing techniques described herein and/or involved in the image processing techniques described herein. The ISP may be configured to control the capture of image frames from one or more image sensors and determine one or more image frames from the one or more image sensors to generate a view of a scene in an output image frame. The output image frame may be part of a sequence of image frames forming a video sequence. The video sequence may include other image frames received from the image sensor or other images sensors.

In an example application, the image signal processor (ISP) may receive an instruction to capture a sequence of image frames in response to the loading of software, such as a camera application, to produce a preview display from the image capture device. The image signal processor may be configured to produce a single flow of output image frames, based on images frames received from one or more image sensors. The single flow of output image frames may include raw image data from an image sensor, binned image data from an image sensor, or corrected image data processed by one or more algorithms within the image signal processor. For example, an image frame obtained from an image sensor, which may have performed some processing on the data before output to the image signal processor, may be processed in the image signal processor by processing the image frame through an image post-processing engine (IPE) and/or other image processing circuitry for performing one or more of tone mapping, portrait lighting, contrast enhancement, gamma correction, etc. The output image frame from the ISP may be stored in memory and retrieved by an application processor executing the camera application, which may perform further processing on the output image frame to adjust an appearance of the output image frame and reproduce the output image frame on a display for view by the user.

After an output image frame representing the scene is determined by the image signal processor and/or determined by the application processor, such as through image processing techniques described in various embodiments herein, the output image frame may be displayed on a device display as a single still image and/or as part of a video sequence, saved to a storage device as a picture or a video sequence, transmitted over a network, and/or printed to an output medium. For example, the image signal processor (ISP) may be configured to obtain input frames of image data (e.g., pixel values) from the one or more image sensors, and in turn, produce corresponding output image frames (e.g., preview display frames, still-image captures, frames for video, frames for object tracking, etc.). In other examples, the image signal processor may output image frames to various output devices and/or camera modules for further processing, such as for 3A parameter synchronization (e.g., automatic focus (AF), automatic white balance (AWB), and automatic exposure control (AEC)), producing a video file via the output frames, configuring frames for display, configuring frames for storage, transmitting the frames through a network connection, etc. Generally, the image signal processor (ISP) may obtain incoming frames from one or more image sensors and produce and output a flow of output frames to various output destinations.

In some aspects, the output image frame may be produced by combining aspects of the image correction of this disclosure with other computational photography techniques such as high dynamic range (HDR) photography or multi-frame noise reduction (MFNR). With HDR photography, a first image frame and a second image frame are captured using different exposure times, different apertures, different lenses, and/or other characteristics that may result in improved dynamic range of a fused image when the two image frames are combined. In some aspects, the method may be performed for MFNR photography in which the first image frame and a second image frame are captured using the same or different exposure times and fused to generate a corrected first image frame with reduced noise compared to the captured first image frame.

In some aspects, a device may include an image signal processor or a processor (e.g., an application processor) including specific functionality for camera controls and/or processing, such as enabling or disabling the binning module or otherwise controlling aspects of the image correction. The methods and techniques described herein may be entirely performed by the image signal processor or a processor, or various operations may be split between the image signal processor and a processor, and in some aspects split across additional processors.

The device may include one, two, or more image sensors, such as a first image sensor. When multiple image sensors are present, the image sensors may be differently configured. For example, the first image sensor may have a larger field of view (FOV) than the second image sensor, or the first image sensor may have different sensitivity or different dynamic range than the second image sensor. In one example, the first image sensor may be a wide-angle image sensor, and the second image sensor may be a tele image sensor. In another example, the first sensor is configured to obtain an image through a first lens with a first optical axis and the second sensor is configured to obtain an image through a second lens with a second optical axis different from the first optical axis. Additionally or alternatively, the first lens may have a first magnification, and the second lens may have a second magnification different from the first magnification. Any of these or other configurations may be part of a lens cluster on a mobile device, such as where multiple image sensors and associated lenses are located in offset locations on a frontside or a backside of the mobile device. Additional image sensors may be included with larger, smaller, or same field of views. The image processing techniques described herein may be applied to image frames captured from any of the image sensors in a multi-sensor device.

In an additional aspect of the disclosure, a device configured for image processing and/or image capture is disclosed. The apparatus includes various components for capturing image frames. The apparatus further includes one or more components for capturing data representative of a scene, such as image sensors (including charge-coupled devices (CCDs), Bayer-filter sensors, infrared (IR) detectors, ultraviolet (UV) detectors, complimentary metal-oxide-semiconductor (CMOS) sensors) and time of flight detectors. The apparatus may further include one or more components for accumulating and/or focusing light rays into the one or more image sensors (including simple lenses, compound lenses, spherical lenses, and non-spherical lenses). These components may be controlled to capture the first and/or second image frames input to the image processing techniques described herein.

Other aspects, features, and implementations will become apparent to those of ordinary skill in the art, upon reviewing the following description of specific, exemplary aspects in conjunction with the accompanying figures. While features may be discussed relative to certain aspects and figures below, various aspects may include one or more of the advantageous features discussed herein. In other words, while one or more aspects may be discussed as having certain advantageous features, one or more of such features may also be used in accordance with the various aspects. In similar fashion, while exemplary aspects may be discussed below as device, system, or method aspects, the exemplary aspects may be implemented in various devices, systems, and methods.

The method may be embedded in a computer-readable medium as computer program code comprising instructions that cause a processor to perform the steps of the method. In some embodiments, the processor may be part of a mobile device including a first network adaptor configured to transmit data, such as images or videos in a recording or as streaming data, over a first network connection of a plurality of network connections; and a processor coupled to the first network adaptor and the memory. The processor may cause the transmission of output image frames described herein over a wireless communications network such as a 5G NR communication network.

The foregoing has outlined, rather broadly, the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, and packaging arrangements. For example, aspects and/or uses may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described innovations may occur. Implementations may range in spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also necessarily include additional components and features for implementation and practice of claimed and described aspects. For example, transmission and reception of wireless signals necessarily includes a number of components for analog and digital purposes (e.g., hardware components including antenna, radio frequency (RF)-chains, power amplifiers, modulators, buffer, processor(s), interleaver, adders/summers, etc.). It is intended that innovations described herein may be practiced in a wide variety of devices, chip-level components, systems, distributed arrangements, end-user devices, etc. of varying sizes, shapes, and constitution.

### BRIEF DESCRIPTION OF THE DRAWINGS

A further understanding of the nature and advantages of the present disclosure may be realized by reference to the following drawings. In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

FIG. 1 shows a block diagram of an example device for performing image capture from one or more image sensors.

FIG. 2A is a block diagram illustrating an example data flow path for image data processing in an image capture device according to one or more embodiments of the disclosure.

FIG. 2B is a block diagram illustrating another example data flow path for image data processing in an image capture device according to one or more embodiments of the disclosure.

FIG. 2C is a block diagram illustrating yet another example data flow path for image data processing in an image capture device according to one or more embodiments of the disclosure.

FIG. 3 shows a flow chart of an example method for processing image data with spatially-adaptive pixel binning according to some embodiments of the disclosure.

FIG. 4A is a diagram of a predefined pattern for processing image data with no binning according to one or more embodiments of the disclosure.

FIG. 4B is a diagram of a spatially-adaptive binning pattern for processing image data with spatially-adaptive pixel binning according to one or more embodiments of the disclosure.

FIG. 5 is a diagram of an example input image frame with an area of interest providing scene-dependent guidance for spatially-adaptive binning according to one or more embodiments of the disclosure.

FIG. 6 is a diagram illustrating various examples of fixed binning patterns for binning pixels of an image according to one or more embodiments of the present disclosure.

FIG. 7 is a diagram illustrating an example of binning pixels of an image using a spatially-adaptive binning pattern according to one or more embodiments of the present disclosure.

FIG. 8 is a block diagram illustrating a data flow for image processing using spatially-adaptive pixel binning according to one or more embodiments of the present disclosure.

FIG. 9 is a block diagram illustrating another data flow for image processing using spatially-adaptive pixel binning according to one or more embodiments of the present disclosure.

FIG. 10 is a block diagram illustrating a data flow for converting spatially-varying binned image data to non-spatially varying binned image data using spatially-adaptive remosaicing according to one or more embodiments of the present disclosure.

Like reference numbers and designations in the various drawings indicate like elements.

### DETAILED DESCRIPTION

The detailed description set forth below, in connection with the appended drawings, is intended as a description of various configurations and is not intended to limit the scope of the disclosure. Rather, the detailed description includes specific details for the purpose of providing a thorough understanding of the inventive subject matter. It will be apparent to those skilled in the art that these specific details are not required in every case and that, in some instances, well-known structures and components are shown in block diagram form for clarity of presentation.

The present disclosure provides systems, apparatus, methods, and computer-readable media that support image processing, including techniques for spatially-adaptive pixel binning and spatially-adaptive remosaicing. The disclosed spatially-adaptive binning techniques may be used to produce binned image data representing a digital image of a scene, where the size, aspect ratio, and/or resolution of the pixels spatially may vary across the image. In some embodiments, a spatially-adaptive binning pattern may be applied to pixels corresponding to different image regions such that a resolution of the binned pixels varies based on the location of a corresponding image region relative to at least one area of interest within the image. The spatially-adaptive binning pattern may be applied with any predefined or scene-dependent binning guidance as desired to preserve details or maximize sensitivity in these areas of the image. Such guidance may be based on, for example, pixel intensity values, a predefined binning map identifying the area(s) of interest, user input selecting a region of interest, or other scene-dependent characteristics of the image (e.g., one or more objects in the scene detected using an object detection algorithm or model). The spatially-adaptive binning pattern applied to a particular image region may be, for example, a binning pattern selected from among a plurality of binning patterns for binning the corresponding pixels of the image region based on the location of that image region relative to the area(s) of interest within the image, e.g., as detected within the image based on the predefined or scene-dependent binning guidance described above.

The spatially-adaptive remosaicing techniques of the present disclosure may be used to convert binned image data with spatially-varying binning patterns (as generated using the disclosed spatially-adaptive binning techniques) to non-spatially varying binned image data (e.g., spatially-fixed binned image data or unbinned image data) with a predefined binning pattern (e.g., a Bayer pattern or other fixed color filter array (CFA) pattern). The binned image data may be converted using, for example, a machine learning model (e.g., an artificial neural network) with pixel interpolation based on metadata identifying the spatially-adaptive binning pattern (or selected binning pattern) applied to the pixels corresponding each image region of the plurality of image regions. In some implementations, the machine learning model may implement one or more neural networks (e.g., a recurrent neural network (RNN), a convolutional neural network (CNN), or other type of neural network) to perform the pixel interpolation and conversion. The neural networks or machine learning models may be trained using various training examples of image data conversions that allow the models to establish relationships between a given set of inputs (e.g., input image data conforming to a spatially-adaptive binning pattern) and a set of outputs (e.g., output image data conforming to a spatially-fixed binning pattern). The binned image data resulting from the conversion may then be processed using a standard image processing pipeline or image signal processor, as will be described in further detail below. As spatially-varying binning patterns are a superset of spatially-fixed binning patterns, the disclosed remosaicing techniques may also be applied to binned image data with spatially-fixed binning patterns. Thus, the disclosed remosaicing techniques help to improve the efficiency of the image processing pipeline by providing a single remosaicing solution that can be applied to different binning pattern variations.

Particular implementations of the subject matter described in this disclosure may be implemented as an in-sensor solution for spatially-adaptive binning to realize one or more of the following potential advantages or benefits. In some aspects, the present disclosure provides techniques for reducing power consumption during image capture operations and/or image processing operations and also for reducing data size required in a memory or buffer. Example operations implementing spatially-adaptive binning to image or video (foveated) compression may result in a substantial reduction in the overall resolution of the image while still preserving most, if not all, of the visual information of interest. By reducing the resolution and therefore, the size of the image data, a higher frame rate may be achieved with less computation and storage requirements. This not only improves data storage and transmission efficiency but also reduces power consumption. Accordingly, the disclosed techniques may be useful for any high-resolution camera sensor.

In the description of embodiments herein, numerous specific details are set forth, such as examples of specific components, circuits, and processes to provide a thorough understanding of the present disclosure. The term “coupled” as used herein means connected directly to or connected through one or more intervening components or circuits. Also, in the following description and for purposes of explanation, specific nomenclature is set forth to provide a thorough understanding of the present disclosure. However, it will be apparent to one skilled in the art that these specific details may not be required to practice the teachings disclosed herein. In other instances, well known circuits and devices are shown in block diagram form to avoid obscuring teachings of the present disclosure.

Some portions of the detailed descriptions which follow are presented in terms of procedures, logic blocks, processing, and other symbolic representations of operations on data bits within a computer memory. In the present disclosure, a procedure, logic block, process, or the like, is conceived to be a self-consistent sequence of steps or instructions leading to a desired result. The steps are those requiring physical manipulations of physical quantities. Usually, although not necessarily, these quantities take the form of electrical or magnetic signals capable of being stored, transferred, combined, compared, and otherwise manipulated in a computer system.

An example device for capturing image frames using one or more image sensors, such as a smartphone, may include a configuration of one, two, three, four, or more camera modules on a backside (e.g., a side opposite a primary user display) and/or a front side (e.g., a same side as a primary user display) of the device. The devices may include one or more image signal processors (ISPs), Computer Vision Processors (CVPs) (e.g., AI engines), or other suitable circuitry for processing images captured by the image sensors. The one or more image signal processors (ISP) may store output image frames (such as through a bus) in a memory and/or provide the output image frames to processing circuitry (such as an applications processor). The processing circuitry may perform further processing, such as for encoding, storage, transmission, or other manipulation of the output image frames.

As used herein, a camera module may include the image sensor and certain other components coupled to the image sensor used to obtain a representation of a scene in image data comprising an image frame. For example, a camera module may include other components of a camera, including a shutter, buffer, or other readout circuitry for accessing individual pixels of an image sensor. In some embodiments, the camera module may include one or more components including the image sensor included in a single package with an interface configured to couple the camera module to an image signal processor or other processor through a bus.

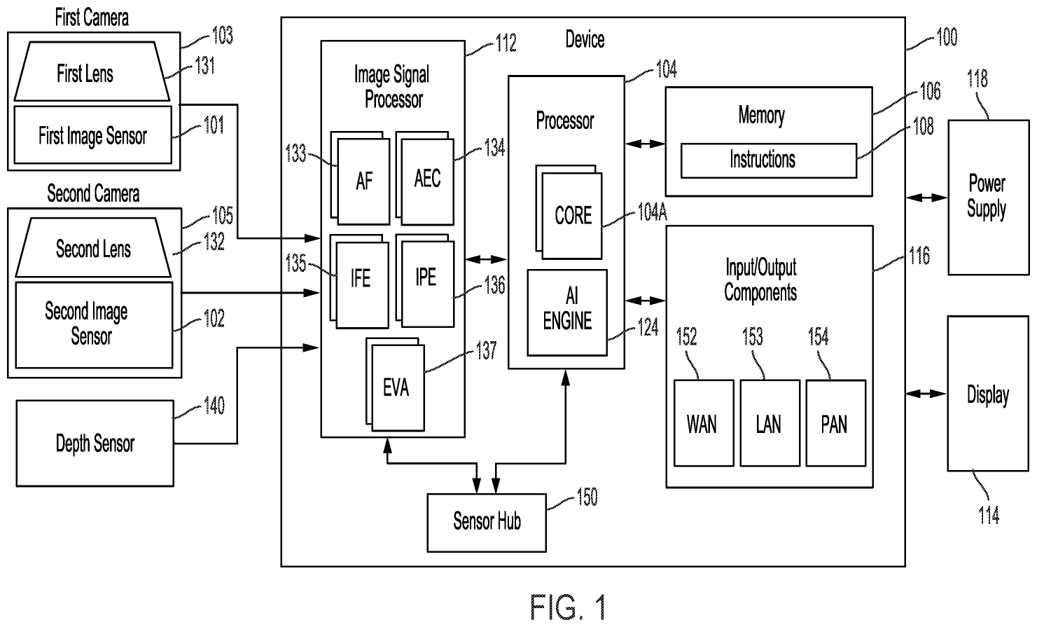

FIG. 1 shows a block diagram of a device 100 for performing image capture from one or more image sensors. The device 100 may include, or otherwise be coupled to, an image signal processor (e.g., ISP 112) for processing image frames from one or more image sensors, such as a first image sensor 101, a second image sensor 102, and a depth sensor 140. In some implementations, the device 100 also includes or is coupled to a processor 104 and a memory 106 storing instructions 108 (e.g., a memory storing processor-readable code or a non-transitory computer-readable medium storing instructions). The device 100 may also include or be coupled to a display 114 and components 116. Components 116 may be used for interacting with a user, such as a touch screen interface and/or physical buttons.

Components 116 may also include network interfaces for communicating with other devices, including a wide area network (WAN) adaptor (e.g., WAN adaptor 152), a local area network (LAN) adaptor (e.g., LAN adaptor 153), and/or a personal area network (PAN) adaptor (e.g., PAN adaptor 154). A WAN adaptor 152 may be a 4G LTE or a 5G NR wireless network adaptor. A LAN adaptor 153 may be an IEEE 802.11 Wi-Fi wireless network adapter. A PAN adaptor 154 may be a Bluetooth wireless network adaptor. Each of the WAN adaptor 152, LAN adaptor 153, and/or PAN adaptor 154 may be coupled to an antenna, including multiple antennas configured for primary and diversity reception and/or configured for receiving specific frequency bands. In some embodiments, antennas may be shared for communicating on different networks by the WAN adaptor 152, LAN adaptor 153, and/or PAN adaptor 154. In some embodiments, the WAN adaptor 152, LAN adaptor 153, and/or PAN adaptor 154 may share circuitry and/or be packaged together, such as when the LAN adaptor 153 and the PAN adaptor 154 are packaged as a single integrated circuit (IC).

The device 100 may further include or be coupled to a power supply 118 for the device 100, such as a battery or an adaptor to couple the device 100 to an energy source. The device 100 may also include or be coupled to additional features or components that are not shown in FIG. 1. In one example, a wireless interface, which may include a number of transceivers and a baseband processor in a radio frequency front end (RFFE), may be coupled to or included in WAN adaptor 152 for a wireless communication device. In a further example, an analog front end (AFE) to convert analog image data to digital image data may be coupled between the first image sensor 101 or second image sensor 102 and processing circuitry in the device 100. In some embodiments, AFEs may be embedded in the ISP 112.

The device may include or be coupled to a sensor hub 150 for interfacing with sensors to receive data regarding movement of the device 100, data regarding an environment around the device 100, and/or other non-camera sensor data. One example non-camera sensor is a gyroscope, which is a device configured for measuring rotation, orientation, and/or angular velocity to generate motion data. Another example non-camera sensor is an accelerometer, which is a device configured for measuring acceleration, which may also be used to determine velocity and distance traveled by appropriately integrating the measured acceleration. In some aspects, a gyroscope in an electronic image stabilization system (EIS) may be coupled to the sensor hub. In another example, a non-camera sensor may be a global positioning system (GPS) receiver, which is a device for processing satellite signals, such as through triangulation and other techniques, to determine a location of the device 100. The location may be tracked over time to determine additional motion information, such as velocity and acceleration. The data from one or more sensors may be accumulated as motion data by the sensor hub 150. One or more of the acceleration, velocity, and/or distance may be included in motion data provided by the sensor hub 150 to other components of the device 100, including the ISP 112 and/or the processor 104.

The ISP 112 may receive captured image data. In one embodiment, a local bus connection couples the ISP 112 to the first image sensor 101 and second image sensor 102 of a first camera 103 and second camera 105, respectively. In another embodiment, a wire interface couples the ISP 112 to an external image sensor (not shown). In a further embodiment, a wireless interface couples the ISP 112 to the first image sensor 101 or second image sensor 102.

The first image sensor 101 and the second image sensor 102 are configured to capture image data representing a scene in the field of view of the first camera 103 and second camera 105, respectively. In some embodiments, the first camera 103 and/or second camera 105 output analog data, which is converted by an analog front end (AFE) and/or an analog-to-digital converter (ADC) in the device 100 or embedded in the ISP 112. In some embodiments, the first camera 103 and/or second camera 105 output digital data. The digital image data may be formatted as one or more image frames, whether received from the first camera 103 and/or second camera 105 or converted from analog data received from the first camera 103 and/or second camera 105.

The first camera 103 may include the first image sensor 101 and a first lens 131. The second camera may include the second image sensor 102 and a second lens 132. Each of the first lens 131 and the second lens 132 may be controlled by an associated an autofocus (AF) algorithm (e.g., AF 133) executing in the ISP 112, which adjusts the first lens 131 and the second lens 132 to focus on a particular focal plane located at a certain scene depth. The AF 133 may be assisted by depth data received from depth sensor 140. The first lens 131 and the second lens 132 focus light at the first image sensor 101 and second image sensor 102, respectively, through one or more apertures for receiving light, one or more shutters for blocking light when outside an exposure window, and/or one or more color filter arrays (CFAs) for filtering light outside of specific frequency ranges. The first lens 131 and second lens 132 may have different field of views to capture different representations of a scene. For example, the first lens 131 may be an ultra-wide (UW) lens and the second lens 132 may be a wide (W) lens. The multiple image sensors may include a combination of ultra-wide (high field-of-view (FOV)), wide, tele, and ultra-tele (low FOV) sensors.

Each of the first camera 103 and second camera 105 may be configured through hardware configuration and/or software settings to obtain different, but overlapping, field of views. In some configurations, the cameras are configured with different lenses with different magnification ratios that result in different fields of view for capturing different representations of the scene. The cameras may be configured such that a UW camera has a larger FOV than a W camera, which has a larger FOV than a T camera, which has a larger FOV than a UT camera. For example, a camera configured for wide FOV may capture fields of view in the range of 64-84 degrees, a camera configured for ultra-side FOV may capture fields of view in the range of 100-140 degrees, a camera configured for tele FOV may capture fields of view in the range of 10-30 degrees, and a camera configured for ultra-tele FOV may capture fields of view in the range of 1-8 degrees.

In some embodiments, one or more of the first camera 103 and/or second camera 105 may be a variable aperture (VA) camera in which the aperture can be adjusted to set a particular aperture size. Example aperture sizes include f/2.0, f/2.8, f/3.2, f/8.0, etc. Larger aperture values correspond to smaller aperture sizes, and smaller aperture values correspond to larger aperture sizes. A variable aperture (VA) camera may have different characteristics that produced different representations of a scene based on a current aperture size. For example, a VA camera may capture image data with a depth of focus (DOF) corresponding to a current aperture size set for the VA camera.

The ISP 112 processes image frames captured by the first camera 103 and second camera 105. While FIG. 1 illustrates the device 100 as including first camera 103 and second camera 105, any number (e.g., one, two, three, four, five, six, etc.) of cameras may be coupled to the ISP 112. In some aspects, depth sensors such as depth sensor 140 may be coupled to the ISP 112. Output from the depth sensor 140 may be processed in a similar manner to that of first camera 103 and second camera 105. Examples of depth sensor 140 include active sensors, including one or more of indirect Time of Flight (iToF), direct Time of Flight (dToF), light detection and ranging (Lidar), mmWave, radio detection and ranging (Radar), and/or hybrid depth sensors, such as structured light sensors. In embodiments without a depth sensor 140, similar information regarding depth of objects or a depth map may be determined from the disparity between first camera 103 and second camera 105, such as by using a depth-from-disparity algorithm, a depth-from-stereo algorithm, phase detection auto-focus (PDAF) sensors, or the like. In addition, any number of additional image sensors or image signal processors may exist for the device 100.

In some embodiments, the ISP 112 may execute instructions from a memory, such as instructions 108 from the memory 106, instructions stored in a separate memory coupled to or included in the ISP 112, or instructions provided by the processor 104. In addition, or in the alternative, the ISP 112 may include specific hardware (such as one or more integrated circuits (ICs)) configured to perform one or more operations described in the present disclosure. For example, the ISP 112 may include image front ends (e.g., IFE 135), image post-processing engines (e.g., IPE 136), auto exposure compensation (AEC) engines (e.g., AEC 134), and/or one or more engines for video analytics (e.g., EVA 137). An image pipeline may be formed by a sequence of one or more of the IFE 135, IPE 136, and/or EVA 137. In some embodiments, the image pipeline may be reconfigurable in the ISP 112 by changing connections between the IFE 135, IPE 136, and/or EVA 137. The AF 133, AEC 134, IFE 135, IPE 136, and EVA 137 may each include application-specific circuitry, be embodied as software or firmware executed by the ISP 112, and/or a combination of hardware and software or firmware executing on the ISP 112.

The memory 106 may include a non-transient or non-transitory computer readable medium storing computer-executable instructions as instructions 108 to perform all or a portion of one or more operations described in this disclosure. The instructions 108 may include a camera application (or other suitable application such as a messaging application) to be executed by the device 100 for photography or videography. The instructions 108 may also include other applications or programs executed by the device 100, such as an operating system and applications other than for image or video generation. Execution of the camera application, such as by the processor 104, may cause the device 100 to record images using the first camera 103 and/or second camera 105 and the ISP 112.

In addition to instructions 108, the memory 106 may also store image frames. The image frames may be output image frames stored by the ISP 112. The output image frames may be accessed by the processor 104 for further operations. In some embodiments, the device 100 does not include the memory 106. For example, the device 100 may be a circuit including the ISP 112, and the memory may be outside the device 100. The device 100 may be coupled to an external memory and configured to access the memory for writing output image frames for display or long-term storage. In some embodiments, the device 100 is a system-on-chip (SoC) that incorporates the ISP 112, the processor 104, the sensor hub 150, the memory 106, and/or components 116 into a single package.

In some embodiments, at least one of the ISP 112 or the processor 104 executes instructions to perform various operations described herein, including operations for converting the spatially-adaptive remosaicing of the binned image data generated by the first image sensor 101 or the second image sensor 102. For example, execution of the instructions can instruct the ISP 112 to begin or end capturing an image frame or a sequence of image frames, in which the capture includes correction as described in embodiments herein. In some embodiments, the processor 104 may include one or more general-purpose processor cores 104A-N capable of executing instructions to control operation of the ISP 112. For example, the cores 104A-N may execute a camera application (or other suitable application for generating images or video) stored in the memory 106 that activate or deactivate the ISP 112 for capturing image frames and/or control the ISP 112 in the application of the spatially-adaptive remosaicing of binned image data to an image format suitable for output via the display 114 or storage within the memory 106. The operations of the cores 104A-N and ISP 112 may be based on user input. For example, a camera application executing on processor 104 may receive a user command to begin a video preview display upon which a video comprising a sequence of image frames is captured and processed from first camera 103 and/or the second camera 105 through the ISP 112 for display and/or storage. Image processing to determine “output” or “corrected” image frames, such as according to techniques described herein, may be applied to one or more image frames in the sequence.

In some embodiments, the processor 104 may include ICs or other hardware (e.g., an artificial intelligence (AI) engine, such as AI engine 124 described above, or other co-processor) to offload certain tasks from the cores 104A-N. The AI engine 124 may be used to offload tasks related to, for example, face detection, object recognition, and/or interpolation operations for spatially-adaptive remosaicing using machine learning (ML) or artificial intelligence (AI). The AI engine 124 may be referred to as an Artificial Intelligence Processing Unit (AI PU). The AI engine 124 may include hardware configured to perform and accelerate convolution operations involved in executing machine learning algorithms, such as by executing predictive models such as artificial neural networks (ANNs) (including multilayer feedforward neural networks (MLFFNN), convolutional neural networks (CNNs), recurrent neural networks (RNN), and/or radial basis functions (RBF)). An ANN executed by the AI engine 124 may access predefined training weights for performing operations on user data. The ANN may alternatively be trained during operation of the image capture device 100, such as through reinforcement training, supervised training, and/or unsupervised training. In some other embodiments, the device 100 does not include the processor 104, such as when all of the described remosaicing functionality is configured in the ISP 112.

In some embodiments, the display 114 may include one or more suitable displays or screens allowing for user interaction and/or to present items to the user, such as a preview of the output of the first camera 103 and/or second camera 105. In some embodiments, the display 114 is a touch-sensitive display. The input/output (I/O) components, such as components 116, may be or include any suitable mechanism, interface, or device to receive input (such as commands) from the user and to provide output to the user through the display 114. For example, the components 116 may include (but are not limited to) a graphical user interface (GUI), a keyboard, a mouse, a microphone, speakers, a squeezable bezel, one or more buttons (such as a power button), a slider, a toggle, or a switch.

While shown to be coupled to each other via the processor 104, components (such as the processor 104, the memory 106, the ISP 112, the display 114, and the components 116) may be coupled to each another in other various arrangements, such as via one or more local buses, which are not shown for simplicity. One example of a bus for interconnecting the components is a peripheral component interface (PCI) express (PCIe) bus.

While the ISP 112 is illustrated as separate from the processor 104, the ISP 112 may be a core of a processor 104 that is an application processor unit (APU), included in a system on chip (SoC), or otherwise included with the processor 104. While the device 100 is referred to in the examples herein for performing aspects of the present disclosure, some device components may not be shown in FIG. 1 to prevent obscuring aspects of the present disclosure. Additionally, other components, numbers of components, or combinations of components may be included in a suitable device for performing aspects of the present disclosure. As such, the present disclosure is not limited to a specific device or configuration of components, including the device 100.

In some embodiments, the exemplary image capture device of FIG. 1 may be operated to obtain improved images by applying the spatially-adaptive binning and remosaicing techniques disclosed herein. Such techniques may be used, for example, to improve the computational efficiency associated with data storage and transmission operations by reducing an amount or number of bits needed to store the binned image data and reducing bandwidth consumed when transferring such reduced data. Such computation, storage, and transmission efficiencies may also lower power consumption and improve battery operating time of a mobile device operating as an image capture device with one or more cameras, such as the first camera 103 and/or the second camera 105.

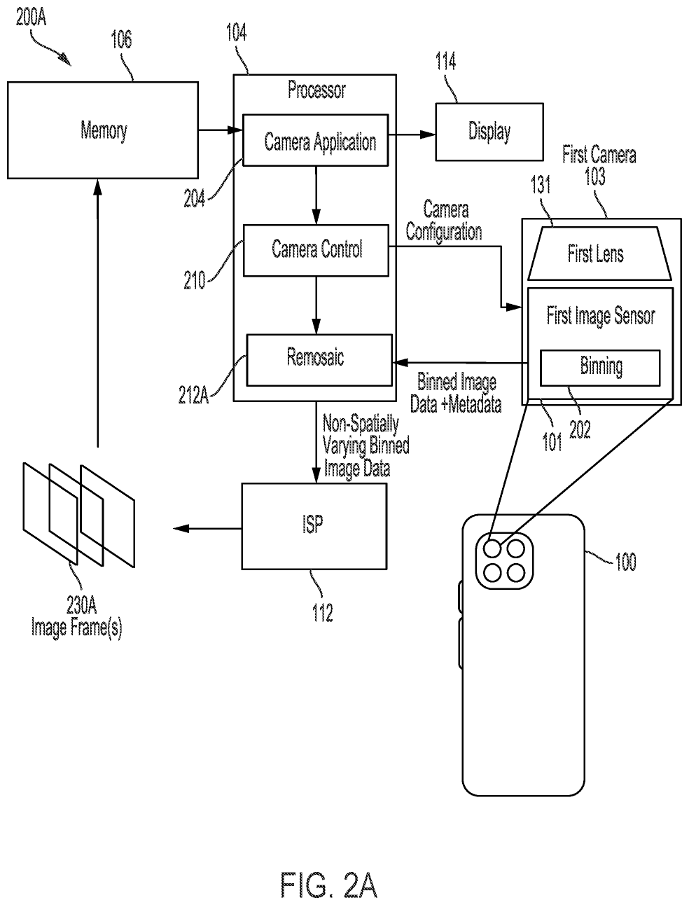

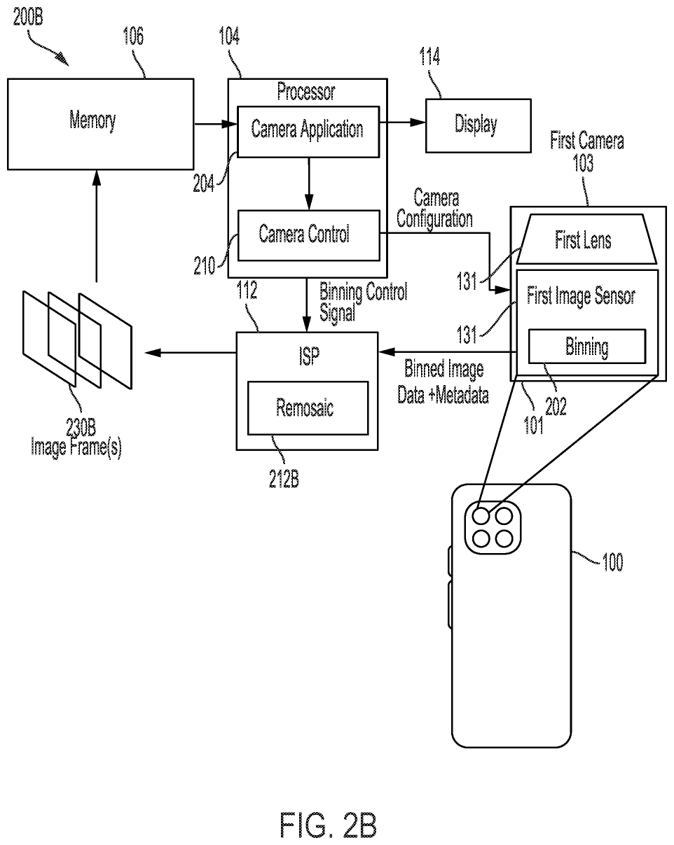

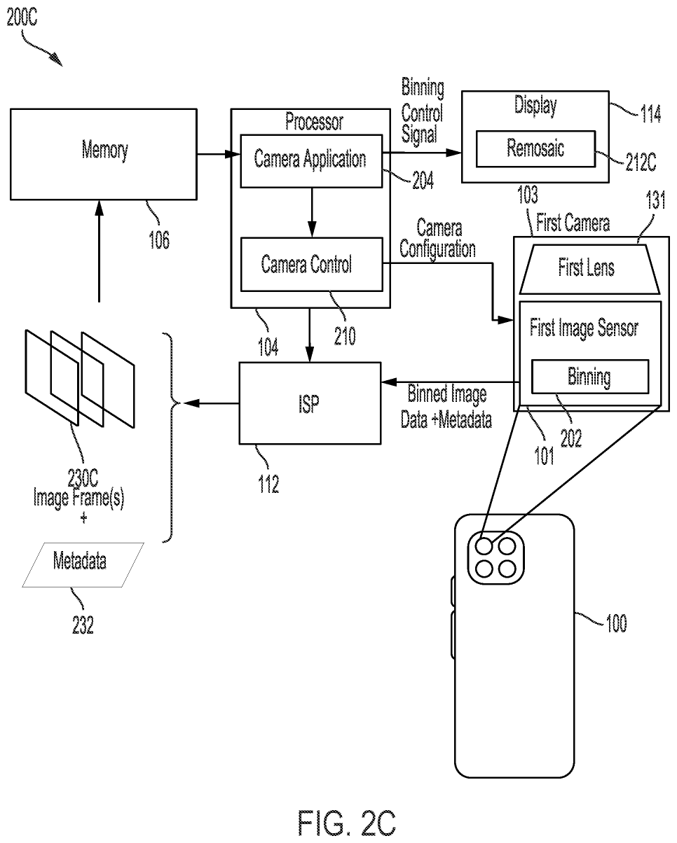

In some embodiments, the first image sensor 101 and/or the second image sensor 102 may include a binning module for applying a spatially-adaptive binning pattern to image data comprising portions of an image frame captured through the first lens 131 and/or second lens 132, respectively. The spatially-adaptive binning pattern may be applied to different portions of the image data corresponding to different regions of the image frame, in which a size, a resolution, and/or an aspect ratio of the binned image data corresponding to each region varies according to one or more criterion, such as the location of the region relative to at least one area of interest within the image frame. In some embodiments, the binning module may generate the binned image data with metadata identifying the spatially-adaptive binning pattern (or binning size) that was applied to each image region. The metadata may be used by a spatially-adaptive remosaic module to convert the binned image data with its spatially-varying binning patterns to non-spatially varying binned image data having a predefined, fixed binning pattern (e.g., the Bayer pattern or other CFA pattern, as desired for a particular implementation). Several example configurations of an image capture device for implementing such a remosaic module in the processor 104, the ISP 112, or the display 114 are shown in FIGS. 2A, 2B, and 2C, respectively, and described below.

FIG. 2A is a block diagram illustrating an example data flow path 200A for image data processing in an image capture device (e.g., device 100 of FIG. 1) according to one or more embodiments of the disclosure. Processor 104 of device 100 may communicate with ISP 112 through a bi-directional bus and/or separate control and data lines. The processor 104 may control the first camera 103 through camera control 210. The camera control 210 may be a camera driver executed by the processor 104 for configuring the first camera 103, such as to active or deactivate image capture, configure exposure settings, configure aperture size, and/or configure the binning module 202. Camera control 210 may be managed by a camera application 204 executing on the processor 104. The camera application 204 provides settings accessible to a user such that the user can specify individual camera settings or select a profile with corresponding camera settings. For example, the user may specify through the camera application 204 an parameter specifying a technique for the spatially-adaptive binning. One example configuration could be a high, low, or off setting, in which the high configuration uses spatially-adaptive binning more aggressively to reduce power consumption than a low configuration and an off configuration disables spatially-adaptive binning. Camera control 210 communicates with the first camera 103 to configure the first camera 103 in accordance with commands received from the camera application 204. The camera application 204 may be, for example, a photography application, a document scanning application, a messaging application, or other application that processes image data acquired from the first camera 103.

The camera configuration may include parameters that specify, for example, a frame rate, an image resolution, a readout duration, an exposure level, an aspect ratio, an aperture size, a spatially-adaptive binning configuration, etc. The first camera 103 may apply the camera configuration and obtain image data representing a scene using the camera configuration. In some embodiments, the camera configuration may be adjusted to obtain different representations of the scene. For example, the processor 104 may execute a camera application 204 to instruct the first camera 103, through camera control 210, to set a first camera configuration for the first camera 103, to obtain first image data from the first camera 103 operating in the first camera configuration, to instruct the first camera 103 to set a second camera configuration for the first camera 103, and to obtain second image data from the first camera 103 operating in the second camera configuration.

In some embodiments in which the first camera 103 is a variable aperture (VA) camera system, the processor 104 may execute a camera application 204 to instruct the first camera 103 to configure to a first aperture size, obtain first image data from the first camera 103, instruct the first camera 103 to configure to a second aperture size, and obtain second image data from the first camera 103. The reconfiguration of the aperture and obtaining of the first and second image data may occur with little or no change in the scene captured at the first aperture size and the second aperture size. Example aperture sizes are f/2.0, f/2.8, f/3.2, f/8.0, etc. Larger aperture values correspond to smaller aperture sizes, and smaller aperture values correspond to larger aperture sizes. That is, f/2.0 corresponds to a larger aperture size than f/8.0.

The image data received from the first camera 103 may be processed in one or more blocks of the processor 104 and/or the ISP 112 to generate one or more image frames 230A that may be stored in memory 106 and/or otherwise provided to the camera application 204 executed by the processor 104 for output to the user via the display 114. The processor 104 may further process the image data to apply effects to the image frame(s) 230A before being sent to the display 114. Effects may include Bokch, lighting, color casting, and/or high dynamic range (HDR) merging. In some embodiments, the effects may be applied in the ISP 112.

The image data processed by the processor 104 may include binned or coded image data generated or encoded by a binning module 202 of the first image sensor 101. As described above, the image data may include different portions of an image frame representative of a scene captured by the first lens 131. In some embodiments, the binning module 202 may encode the image data as it is captured through the first lens 131, e.g., as part of a stream of image data received from the image sensor 101. For example, the binning module 202 may encode the image data by applying a spatially-adaptive binning pattern to bin pixels corresponding to different regions of the image frame. In some embodiments, the spatially-adaptive binning pattern may vary a size, an aspect ratio, and/or a resolution of the image pixels within each region based on one or more criteria. Such criteria may include, for example, a location of each region relative to one or more areas of interest within the image frame or other scene-dependent binning information, such as the relative pixel intensity (e.g., relative brightness or color values of pixels) or pixel saliency (e.g., relative visual prominence or importance of pixels) in each region (e.g., for purposes of foveated image or video compression). Accordingly, the binned image data generated by the binning module 202 may have spatially-varying binning patterns with spatially-varying resolutions, pixel sizes, and/or aspect ratios across the different regions of the input image frame. In addition to the binned image data, the binning module 202 may generate metadata identifying the type of spatially-adaptive binning pattern applied to the portion of the image data corresponding to each image region of the image frame.

The output of the binning image data and metadata may be provided to the processor 104, the image signal processor 112, other processing logic, and/or a combination thereof. In one example, as shown in FIG. 2A, the binned image data along with the metadata may be transmitted by the first image sensor 101 (or the binning module 202 thereof) to a remosaic module 212A of the processor 104. For example, the binning module 202 may indicate, along with a portion of the binned image data, the spatially-adaptive binning pattern used to encode that portion. The metadata may be embedded within the binned image data and the combined data (the binned image data plus the metadata) may be transmitted over a data bus to the processor 104 for processing by the remosaic module 212A. The metadata may alternatively be provided on a separate bus in parallel with the binned image data.

The remosaic module 212A may use the metadata to convert the binned image data with its spatially-varying binning patterns to non-spatially varying binned image data with a predefined spatially-fixed binning pattern (e.g., the Bayer pattern). In some embodiments, the conversion of the binned image data for each image region of the image frame may be performed by remosaic module 212A using a machine learning model (e.g., an artificial neural network) with pixel interpolation based on the metadata associated with that region. For example, the remosaic module 212A may be implemented using an AI engine (e.g., AI engine 124 of FIG. 1, as described above) of the processor 104. The remosaic module 212A, e.g., as part of the Al engine, may execute a machine learning model to convert the spatially-adaptive (or spatially-varying) binned image data to spatially-fixed binned image data using pixel interpolation based on the metadata identifying the spatially-adaptive binning pattern applied to each image region of the input image frame. As described above, the machine learning model in some implementations may include one or more neural networks (e.g., a RNN, a CNN, or other type of artificial neural network (ANN)) to perform the pixel interpolation and conversion. The neural networks or machine learning models may be trained using various training examples of image data conversions that allow the models to establish relationships between a given set of inputs (e.g., input image data conforming to a spatially-adaptive binning pattern) and a set of outputs (e.g., output image data conforming to a spatially-fixed binning pattern). The binned image data output by the remosaic module 212A may then be provided to the ISP 112, which processes the binned image data and generates the image frame(s) 230A accordingly. In some implementations, the spatially-fixed binning pattern (e.g., the Bayer pattern or other CFA pattern) of the binned image data may be a required format for the data to be processed by the ISP 112.

The output image frames 230A generated by the ISP 112 may include representations of the scene based on the image data captured by the first image sensor 101 and improved by aspects of this disclosure. For example, the disclosed spatially-adaptive binning and remosaic techniques may allow the image data to be captured and processed with improved computational efficiency by spatially varying the resolution, size, and/or aspect ratio of the pixels in different image regions to reduce the storage and bandwidth requirements for processing and transferring data (e.g., the binned image data and metadata) in the image capture device 100. The processor 104 may display the image frame(s) 230A to a user via the display 114, and the efficiency improvements provided by the described processing implemented in the first image sensor 101 (with binning module 202) and the processor 104 (with remosaic module 212A) may improve the user experience by reducing power consumption in the transfer of binned image data across data buses to allow users to use the device 100 for a longer period for viewing the image frame(s) 230A. It should be appreciated that the image frame(s) 230A may be upscaled (e.g., by the ISP 112 or by a display processor in the display 114) from a binned or reduced resolution to a higher resolution (e.g., the full resolution of the original image before it is encoded in the first image sensor 101) before being displayed or output to the user via the display 114.

The disclosed techniques may also improve the user experience by enabling the size of the image data to be reduced without sacrificing image quality in areas of interest or noise performance in other areas of the image. For example, the spatially-adaptive binning performed by the binning module 202 in the first image sensor 101 may enhance the image quality of an area of interest (e.g., an area representing a person or other subject in the scene) by preserving most or all of the image details and pixel resolution within this area of the image while also increasing the imaging sensitivity for better noise suppression in other areas, such as low-light or background areas of the image (e.g., areas in the background of the scene that are outside the area of interest), by binning larger groups of pixels to form “super-pixels” in these areas of the image.

Another configuration of the image capture device for implementing the spatially-adaptive remosaicing techniques described herein is shown in FIG. 2B. FIG. 2B is a block diagram illustrating an example data flow path 200B for image data processing in the image capture device 100. As shown in FIG. 2B, the binned image data and metadata generated by the binning module 202 of the first image sensor 101 in this example is transmitted to a remosaic module 212B implemented in the ISP 112. Like the metadata in FIG. 2A described above, the metadata in the example of FIG. 2B may be embedded or combined with the binned image data and the combined data may be transmitted over a data bus to the ISP 112 for processing by the remosaic module 212B. Alternatively, the first image sensor 101 (or the binning module 202 thereof) may transmit the binned image data and the metadata through separate buses or interfaces (e.g., a first interface and a second interface, respectively) to the ISP 112 (or the remosaic module 212B thereof). The remosaic module 212B of the ISP 112 may perform the spatially-adaptive remosaicing operations as performed by remosaic module 212A described above. The ISP 112 may output one or more image frames 230B that may be stored in memory 106 and/or otherwise provided to the camera application 204 executed by the processor 104 for output to the user via the display 114. The image frame(s) 230B, like the image frame(s) 230A of FIG. 2A described above, may be upscaled (e.g., by other components in the ISP 112 or by a display processor in the display 114) from a binned or reduced resolution to a higher resolution (e.g., the full resolution of the original image before it is encoded in the first image sensor 101) before being output via the display 114.

Another configuration of the image capture device for implementing the spatially-adaptive remosaicing techniques described herein is shown in FIG. 2C. FIG. 2C is a block diagram illustrating an example data flow path 200C for image data processing in the image capture device 100. As in the preceding example of FIG. 2B, the binned image data and metadata generated by the binning module 202 of the first image sensor 101 in FIG. 2C is transmitted to the ISP 112. Unlike the preceding examples in FIGS. 2A and 2B, however, the remosaicing operations in FIG. 2C are performed by a remosaic module 212C implemented in the display 114, after the binned image data has been processed by the ISP 112. Therefore, the remosaicing performed by the remosaic module 212C may involve not only converting the spatially-varying binned image data to spatially-fixed binned image data but also converting the spatially-fixed binned image data to non-binned image data with a higher resolution (e.g., the full resolution of the original image before it is encoded in the first image sensor 101). The remosaic module 212C may be implemented in the display 114 as hardware (e.g., in a display processor of the display 114) and/or software (e.g., as instructions or code executable by the display processor). The ISP 112 in this example may generate one or more output image frames 230C, which may be stored in memory 106 and/or otherwise provided to the camera application 204 executed by the processor 104. As described above, the processor 104 may further process the image data to apply effects (e.g., Bokch, lighting, color casting, and/or HDR merging) to the image frame(s) 230C before sending the image frame(s) 230C to the display 114 for visualization or display to a user. Although the remosaicing corresponding to the final format for output by the display 114 is not performed in ISP 112, the ISP 112 may perform other remosaicing operations.

Unlike the image frame(s) 230A and 230B in FIGS. 2A and 2B, the image frame(s) 230C may correspond to binned image data representing different image regions having spatially-varying resolutions and/or aspect ratios. The remosaic module 212C may convert portions of the binned image data by converting the image data from a spatially-varying binning pattern to a full RGB image and upscaling the corresponding image regions having reduced aspect ratios before displaying the image frame(s) 230C. The conversion and upscaling by the remosaic module 212C may be based on metadata 232 output by the ISP 112 and stored in memory 106 before being passed to the remosaic module 212C, e.g., via the binning control signal sent by the processor 104. The metadata 232 may identify a binning size and/or aspect ratio for each portion of the image data to be decoded by the remosaic module 212C.

As the display 114 may represent a final processing stage in the image processing pipeline before the image data is visualized or displayed, an advantage of the configuration shown in FIG. 2C over the other configurations is that the reduced size of the binned image data can be maintained throughout the image processing pipeline. The entire pipeline benefits from the substantial computation and storage savings provided by the reduced size of the image data. Thus, implementing the spatially-adaptive remosaicing and upscaling in the display 114 further improves the computation, storage and transmission bandwidth efficiency gained by the use of spatially-adaptive binning.

In some embodiments of the device configurations shown in FIG. 2B and FIG. 2C, binning control information may be provided as a hardware signal by the camera application 204 to the ISP 112 or the display 114, respectively. In some embodiments, such a binning control signal may be used to provide indications of binning sizes or other information (e.g., a desired non-binned data format, fixed binning pattern, pixel color values, etc.) to be used by the remosaic module 212B or the remosaic module 212C when converting or decoding different portions of the binned image data in each configuration.

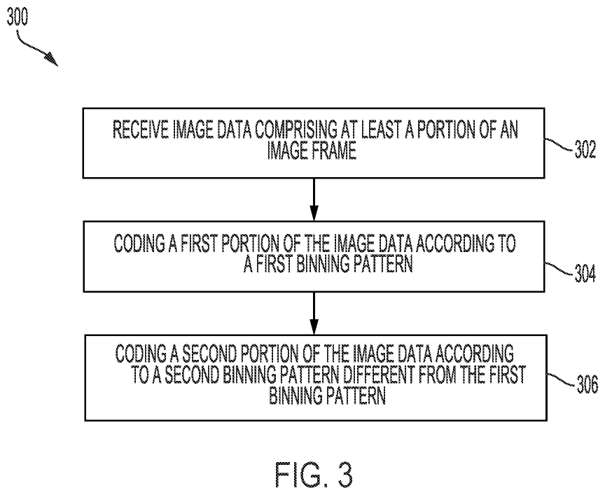

The various configurations of the image capture device shown in FIGS. 2A, 2B, and 2C may be used to perform the image data processing operations described with reference to FIG. 3. FIG. 3 shows a flow chart of an example method 300 for processing image data with spatially-adaptive pixel binning according to some embodiments of the disclosure. The operations described with reference to FIG. 3 may be performed by one or a combination of the processor 104 (including cores 104A-N or AI engine 124), the ISP 112, and/or the display 114.

At block 302, image data comprising at least a portion of an image frame is received. The image data may be received from an image sensor (e.g., the first image sensor 101 described above). The image data may be received, for example, from the first lens 131 of the first camera 103 as the data is captured by the first lens 131. In some embodiments, the capture of image data may be initiated by a camera application executing on the processor 104, which causes camera control 210 to activate capture of image data by the first camera 103.

At block 304, a first portion of the image data is coded according to a first binning size. The coding of the first portion may include encoding the first portion by the image sensor to determine first coded data.

At block 306, a second portion of the image data is coded according to a second binning size different from the first binning size. The coding of the second portion may include encoding the second portion by the image sensor to determine second coded data.

In some embodiments, the first coded data and the second coded data may be transmitted through a first interface of the image sensor to an image signal processor (e.g., ISP 112). Additionally, metadata may be transmitted through a second interface of the image sensor to the image signal processor. The metadata may include a first indication of the first binning size for the first coded data and a second indication of the second binning size for the second coded data. The first coded data may be decoded by a remosaic module based on the first binning size indicated by the metadata. Likewise, the second coded data may be decoded by the remosaic module based on the second binning size indicated by the metadata. The decoded data corresponding to the first and second portions may then be processed to determine the image frame, e.g., to be stored within memory 106 or output for display to a user via the display 114, as described above.

As described above, a spatially-adaptive binning pattern may be applied to pixels corresponding to different image regions such that a resolution of the coded data (or binned pixels) varies based on the location of a corresponding image region relative to at least one area of interest within the image. The spatially-adaptive binning pattern may be applied with any predefined or scene-dependent binning guidance as desired to preserve details or maximize sensitivity in these areas of the image. Such guidance may be based on, for example, pixel intensity values, a predefined binning map identifying the area(s) of interest, or other scene-dependent characteristics of the image (e.g., one or more objects in the scene detected using an object detection algorithm or model). To later convert the binned image data with spatially-varying binning patterns to binned image data with a predefined color filter array (CFA) pattern (e.g., Bayer pattern), spatially-adaptive remosaicing may be performed to decode the coded data based on the binning information indicated by the metadata.

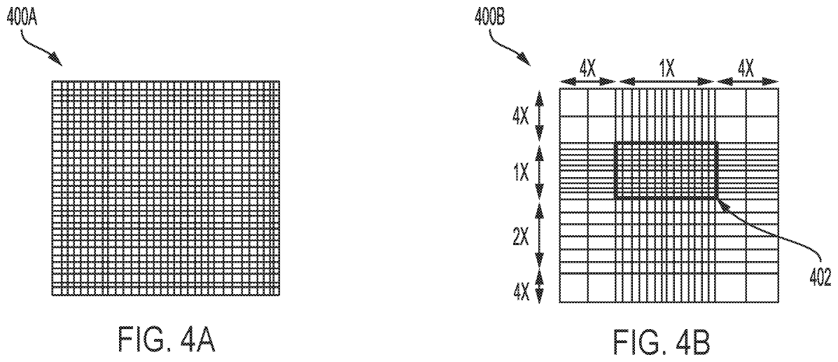

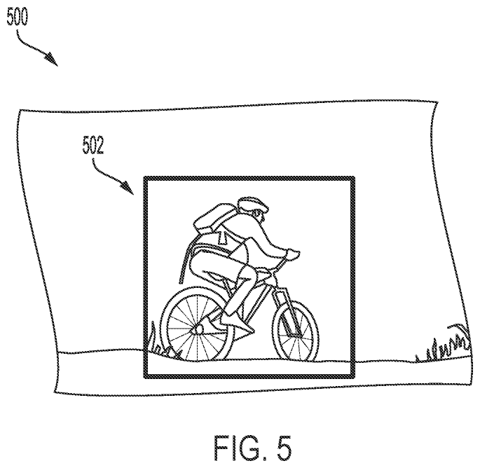

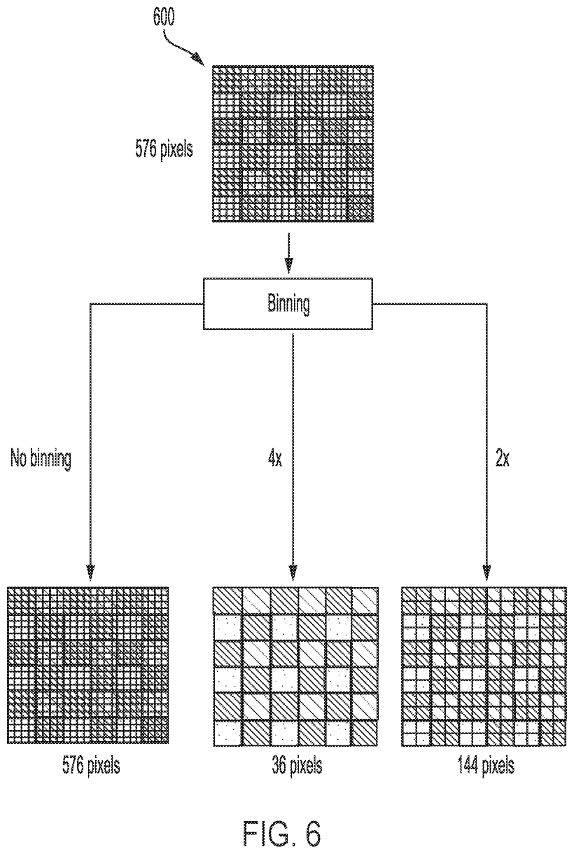

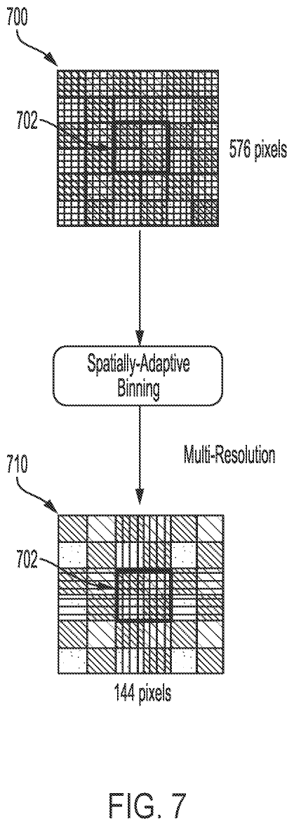

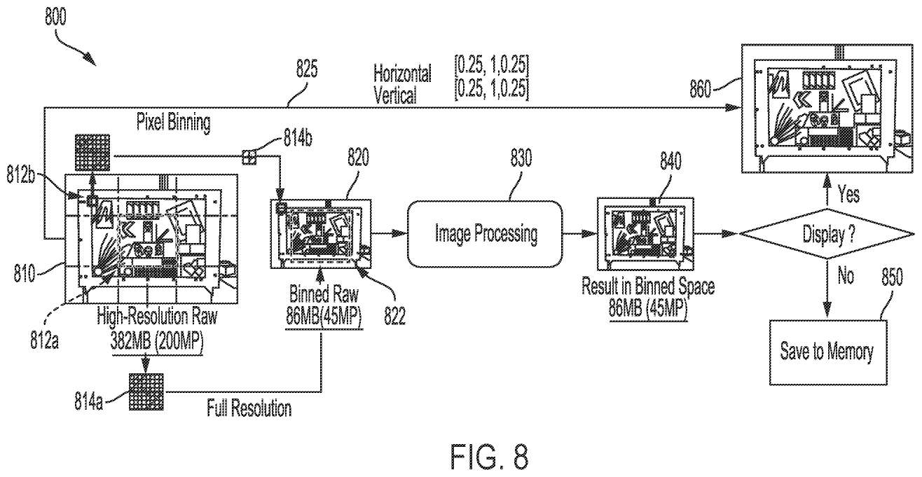

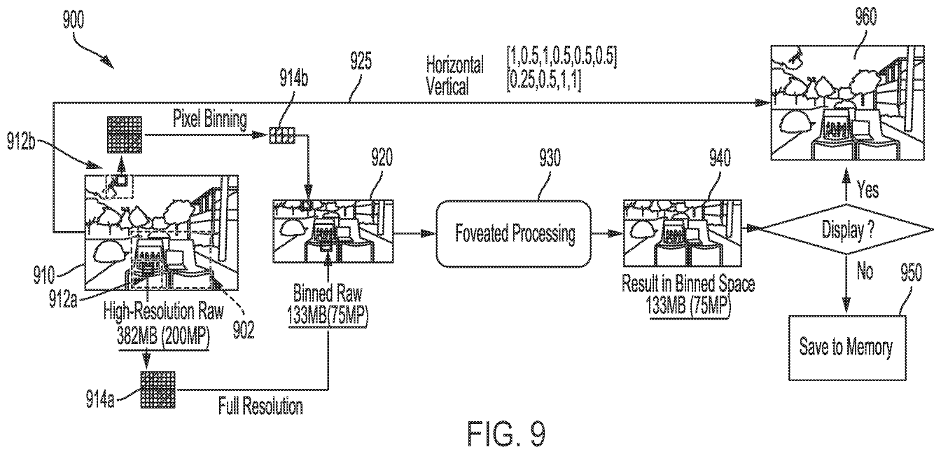

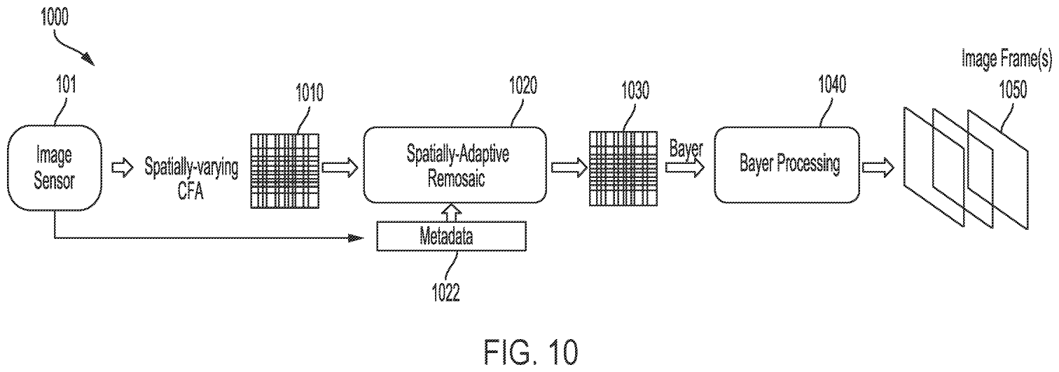

Several example use cases and workflows for spatially-adaptive binning and remosaicing of image data according to different embodiments of this disclosure will be described below with reference to FIG. 4A, FIG. 4B, FIG. 5, FIG. 6, FIG. 7, FIG. 8, FIG. 9, and FIG. 10. Different embodiments for applying spatially-adaptive binning techniques to bin pixels of an image along with the benefits of such techniques over conventional pixel-binning techniques that rely on a fixed or predefined binning pattern are described with reference to the examples shown in FIG. 4A, FIG. 4B, FIG. 5, FIG. 6, and FIG. 7. The spatially-adaptive binning techniques described in these figures may be applied to image data with either predefined or scene-dependent binning guidance for different image processing workflows as shown in FIG. 8 and FIG. 9. The spatially-varying binned image data resulting from the workflows of FIG. 8 or FIG. 9 may be converted to non-spatially varying binned image data using a spatially-adaptive remosaicing workflow as shown in FIG. 10.

FIG. 4A is a diagram of a predefined or fixed color filter array (CFA) pattern 400A for processing image data with no binning according to one or more embodiments of the disclosure. The pixel size, aspect ratio, and resolution of the binning pattern 400A is uniform across the entire pattern. By contrast, FIG. 4B shows a spatially-adaptive binning pattern 400B for processing image data, where the pixel sizes, aspect ratios, and/or resolutions spatially vary across different regions of the image frame represented by the image data. In some embodiments, a portion of the image data may correspond to a region of the image frame within an area of interest 402. Remaining portions of the image data may correspond to regions outside the area of interest 402. In some embodiments, the spatially-adaptive binning pattern 400B may be applied to encode or bin pixels within each region of the image frame such that the pixel size, aspect ratio, and/or resolution of the binned pixels varies based on the location of the corresponding image region relative to the at least one area of interest 402.

FIG. 5 is a diagram of an example image frame 500 with an area of interest 502. The area of interest 502 in this example may represent one or more regions of the image frame 500 corresponding to a subject (such as a person and/or other object within the scene) of the image. In some embodiments, the area of interest 502 may be detected using, for example, an object detection model or based on scene-dependent information (e.g., pixel intensity values distinguishing low-light versus well-lit areas of the scene or a pixel saliency map highlighting visually significant regions or objects in the image). Alternatively, the area of interest 502 may be based on a predefined binning map identifying the at least one area of interest within the input image frame. The predefined map may be generated based on, for example, input received from a user of the image capture device via an image preview function of a touch-screen display.

In some embodiments, the area of interest 502 may be used to provide scene-dependent guidance for spatially-adaptive binning of the image data. For example, the spatially-adaptive binning performed by the binning module 202 in the first image sensor 101, as described above with respect to FIGS. 2A, 2B, and 2C, may enhance the image quality of regions corresponding to the area of interest by preserving most or all of the image details and pixel resolution within this area of the image. Additionally, the imaging sensitivity in other areas, such as low-light or background areas of the image (e.g., areas in the background of the scene that are outside the area of interest), may be increased for better noise suppression by binning larger groups of pixels to form “super-pixels” in these other areas of the image.

FIG. 6 is a diagram illustrating examples of various fixed binning patterns for an image 600 including 576 pixels. As shown in FIG. 6, with no binning, all 576 pixels of the image 600 are preserved. By coding the image using either a 4×4 binning pattern or a 2×2 binning pattern, however, the total number of pixels is reduced to 36 pixels and 144 pixels, respectively. With spatially adaptive binning, an image frame may be grouped into regions corresponding to pixels 600 and each different set of pixels 600 may be differently binned according to either no binning, 4× binning, or 2× binning, an illustration of which is shown in FIG. 7.

FIG. 7 is a diagram illustrating an example of a spatially-adaptive binning for coding an image 700, which also includes 576 pixels like the image 600 of FIG. 6. The use of spatially-adaptive binning may spread data across the image frame such that more data is used where more detail is desired or present. Thus, a similar or smaller amount of data may be used to store an image with similar image quality. For example, pixels corresponding to regions at the four corners of the image 700 may be binned using a 4×4 binning pattern while the pixels within the regions adjacent to the area of interest 702 may be binned using a 4×2 pattern to have a relatively higher resolution than the corner regions while still having a lower resolution than the area of interest 702. Thus, the spatially-adaptive binning pattern allows the image details within the area of interest 702 to be preserved without significantly increasing the overall data size of the image or significantly degrading noise performance or sensitivity in other areas (e.g., low-light areas) of the image.

Different example data flows for image processing using the disclosed spatially-adaptive binning and remosaicing techniques are shown in FIG. 8 and FIG. 9. It is assumed for purposes of these examples that the image capture device in which the disclosed techniques are implemented is configured according to the configuration shown in FIG. 2C, as described above. Accordingly, it is assumed that spatially-adaptive binning is applied to image data in the first image sensor 101 (e.g., by the binning module 202 as described above) and that spatially-adaptive remosaicing for converting or decoding the binned image data is performed in the display 114 (e.g., by the remosaic module 212C of FIG. 2C as implemented or executed by a display processor of the display 114).

FIG. 8 is a block diagram illustrating an example data flow 800 for image processing with spatially-adaptive pixel binning according to one or more embodiments of the present disclosure. As shown in FIG. 8, a high-resolution raw image 810 (e.g., captured by the first camera 103 of FIG. 1) may include pixels corresponding to one of nine image regions arranged in a two-dimensional (2D) grid. It should be appreciated that the image regions may be equally-sized sections of the 2D grid or the individual regions may vary in size as desired for a particular implementation. A region 812a may represent an area of interest 822, as shown in image 820, which may be a binned version of the raw image 810. In some embodiments, the area of interest 822 may be predefined (e.g., based on a predefined binning map identifying the area of interest 822) to provide guidance for the spatially-adaptive binning. The pixels corresponding to the region 812a (the area of interest) in this example are binned using a 1×1 binning pattern to produce a region 814a that preserves the full resolution of the original region 812a. The pixels corresponding to a region 812b located outside the area of interest are binned according to a binning size of four (or a 4×4 binning pattern), where four pixels in the horizontal and vertical dimensions of each 4×4 group of pixels are combined to produce a binned region 814b with a resolution that is 25% of the resolution of the original region 812b.

The binned image 820 (including binned image data with spatially-varying resolutions) is processed (e.g., by ISP 112 of FIG. 1) at block 830 of the data flow 800. The image processing at block 830 outputs processed binned image data 840. The processing performed at block 830 may include, for example, tone mapping, portrait lighting, contrast enhancement, gamma correction, or any other image post-processing operation or any combination of the foregoing. The processed image data 840 may be saved to memory (e.g., the memory 106) at a block 850. Alternatively, the processed image data 840 may be displayed for a user (e.g., via the display 114) at a block 860. If the data 840 is displayed at block 860, a display processor of the display device may first decode and/or upscale the binned image data using spatially-adaptive remosaicing (e.g., using the remosaic module 212C of FIG. 2C, as described above). The spatially-adaptive remosaicing may be based on indications of the varying horizontal and vertical binning sizes/patterns provided by metadata 825, e.g., as part of the binning control information or signal received by the display 114 from the processor 104 in FIG. 2C, as described above.

FIG. 9 is a block diagram illustrating an example data flow 900 for image processing with spatially-adaptive pixel binning according to one or more embodiments of the present disclosure. As shown in FIG. 9, a high-resolution raw image 910 may include pixels corresponding to one of 24 image regions arranged in a 2D grid. As noted in the example above, it should be appreciated that the individual image regions in this example may correspond to equally-sized sections of the 2D grid or vary in size as desired for a particular implementation. An area of interest 902 of the image 910 includes a region 912a (and other image regions). In some embodiments, the area of interest 902 may be detected based on one or more criteria, e.g., pixel intensities or other scene-dependent information as described above. The pixels corresponding to the region 912a (within the area of interest) are binned using a 1×1 binning pattern to produce a binned region 914a that preserves the full resolution of the region 912a. The pixels corresponding to a region 912b located outside the area of interest 902 in this example are binned according to a binning size of two by four (i.e., a 2×4 binning pattern), where two pixels in the horizontal dimension of each 4×4 group of pixels are combined and four pixels in the vertical dimension of each 4×4 group of pixels are combined such that the resolution of the resulting binned region 914b is 50% in the horizontal dimension and 25% in the vertical dimension of the resolution of the original region 912b. While the region 912b, like the region 812b in FIG. 8, is outside the area of interest, a smaller binning size is used for the region 912b such that the resolution of the resulting binned region 914b is reduced by a smaller amount (i.e., 50% vs. 75% in the horizontal dimension).

In some embodiments, the scene-dependent criteria used to detect the area of interest may also be used as binning guidance to determine an appropriate binning size or pattern to be applied to the pixels in a given region such that the image resolution spatially varies according to the selected criteria. The binned image data 920 (with spatially-varying resolutions) is then transmitted to, for example, the ISP 112 of FIG. 1 for foveated image processing at block 930 of the data flow 800. The foveated image processing may include varying the image resolution, or amount of detail, across different regions throughout the image, wherein the highest resolution region is the central region corresponding to the center of the human eye's retina (or fovea). The output of the image processing at block 830 may include processed image data 940 in binned space (i.e., processed or foveated binned image data), which may be either saved to memory (e.g., the memory 106) at a block 950 or displayed for a user (e.g., by the display 114) at a block 960 after the binned image data is decoded and/or upscaled using spatially-adaptive remosaicing as described above, e.g., based on indications of the varying horizontal and vertical binning sizes/patterns included in metadata 925.

FIG. 10 is a block diagram illustrating a data flow 1000 for converting spatially-varying binned image data to non-spatially varying or spatially-fixed binned image data using spatially-adaptive remosaicing according to one or more embodiments of the present disclosure. As shown in FIG. 10, the data flow 1000 begins with the image sensor 101 outputs binned or coded image data with spatially-varying binning patterns at block 1010. The coded image data is then decoded into a Bayer pattern using spatially-adaptive remosaicing at block 1020 based on metadata 1022 that was also output by the image sensor 101. In some embodiments, the spatially-adaptive remosaicing at block 1020 may include using different pixel interpolations for different image regions to convert the corresponding image data from the spatially-adaptive binning pattern specified for that region by the metadata 1022 to a spatially-fixed binning pattern. At block 1030, the decoded image data resulting from the spatially-adaptive remosaicing is provided for further image processing at block 1040 according to the Bayer pattern. In some implementations, the Bayer processing at block 1040 may include using one or more demosaicing algorithms to interpolate a set of complete red, green, and blue values for each pixel based on corresponding color values of the surrounding pixels. The Bayer processing at block 1040 may be performed by, for example, the ISP 112 of FIG. 1, as described above. In some implementations, the Bayer pattern may be a required format for certain operations or stages of the image processing pipeline in the ISP 112. The output of the Bayer processing at block 1040 may be one or more image frames. At block 1050, the image frame(s) may either be stored within the memory 106 or provided as output for display to a user via the display 114.

In one or more aspects, techniques for supporting image processing may include additional aspects, such as any single aspect or any combination of aspects described below or in connection with one or more other processes or devices described elsewhere herein. In a first aspect, supporting image processing may include an apparatus configured to process data captured from an image sensor. The apparatus is further configured to perform operations comprising: receiving image data comprising at least a portion of an image frame; coding a first portion of the image data according to a first binning size; and coding a second portion of the image data according to a second binning size different from the first binning size.

Additionally, the apparatus may perform or operate according to one or more aspects as described below. In some implementations, the apparatus includes a wireless device, such as a UE. In some implementations, the apparatus includes a remote server, such as a cloud-based computing solution, which receives image data for processing to determine output image frames. In some implementations, the apparatus may include at least one processor, and a memory coupled to the processor. The processor may be configured to perform operations described herein with respect to the apparatus. In some other implementations, the apparatus may include a non-transitory computer-readable medium having program code recorded thereon and the program code may be executable by a computer for causing the computer to perform operations described herein with reference to the apparatus. In some implementations, the apparatus may include one or more means configured to perform operations described herein. In some implementations, a method of wireless communication may include one or more operations described herein with reference to the apparatus.

In a second aspect, in combination with the first aspect, the first portion corresponds to an area of interest including a first region of the image frame, and the second portion corresponds to a second region of the image frame outside the area of interest.

In a third aspect, in combination with one or more of the first aspect or the second aspect, the first portion includes first pixel data indicating a first pixel intensity of the first region, wherein the second portion includes second pixel data indicating a second pixel intensity of the second region, and the apparatus is further configured to perform operations comprising detecting the area of interest by determining that the first pixel intensity of the first region is higher than the second pixel intensity of the second region.

In a fourth aspect, in combination with one or more of the first aspect through the third aspect, coding the first portion comprises coding the first portion to determine first coded data having a first resolution for the first region based on the first binning size; coding the second portion comprises coding the second portion to determine second coded data having a second resolution for the second region based on the second binning size; and the second resolution is lower than the first resolution.

In a fifth aspect, in combination with one or more of the first aspect through the fourth aspect, the apparatus is further configured to perform operations comprising generating metadata identifying the first binning size for the first portion and the second binning size for the second portion.

In a sixth aspect, in combination with one or more of the first aspect through the fifth aspect, coding the first portion comprises encoding, by an image sensor, the first portion to determine first coded data; coding the second portion comprises encoding, by the image sensor, the second portion to determine second coded data; and the apparatus is further configured to perform operations comprising transmitting the first coded data and the second coded data through a first interface to an image signal processor.

In a seventh aspect, in combination with one or more of the first aspect through the sixth aspect, the apparatus is further configured to perform operations comprising transmitting metadata through a second interface to the image signal processor, the metadata comprising a first indication of the first binning size for the first coded data and a second indication of the second binning size for the second coded data.

In an eighth aspect, in combination with one or more of the first aspect through the seventh aspect, receiving the image data comprises receiving the image data with metadata comprising a first indication of the first binning size for the first portion and a second indication of the second binning size for the second portion; coding the first portion comprises decoding the first portion to determine first decoded data based on the first indication; coding the second portion comprises decoding the second portion to determine second decoded data based on the second indication; and the apparatus is further configured to perform operations comprising determining the image frame by processing the first decoded data and the second decoded data.

In a ninth aspect, in combination with one or more of the first aspect through the eighth aspect, decoding the first portion comprises remosaicing a first format of the first decoded data to a second format of the image frame.

In a tenth aspect, in combination with one or more of the first aspect through the ninth aspect, coding the first portion comprises decoding the first portion to determine first decoded data; coding the second portion comprises decoding the second portion to determine second decoded data.

In an eleventh aspect, in combination with one or more of the first aspect through the tenth aspect, an apparatus includes a memory storing processor-readable code; and at least one processor coupled to the memory, the at least one processor configured to execute the processor-readable code to cause the at least one processor to perform operations including: receiving image data comprising at least a portion of an image frame; coding a first portion of the image data according to a first binning pattern; and coding a second portion of the image data according to a second binning pattern different from the first binning pattern.

In a twelfth aspect, in combination with one or more of the first aspect through the eleventh aspect, the apparatus is further configured to perform operations comprising transmitting the first decoded data and the second decoded data to a display device.

In a thirteenth aspect, in combination with one or more of the first aspect through the twelfth aspect, the first portion corresponds to a first region in an area of interest of the image frame, and wherein the second portion corresponds to a second region of the image frame outside the area of interest.

In a fourteenth aspect, in combination with one or more of the first aspect through the thirteenth aspect, the operations performed by the at least one processor further include: identifying the area of interest based on a comparison between a first pixel intensity of image regions located within the area of interest and a second pixel intensity of image regions located outside the area of interest.

In a fifteenth aspect, in combination with one or more of the first aspect through the fourteenth aspect, coding the first portion comprises coding the first portion to determine first coded data having a first resolution for the first region based on the first binning pattern; coding the second portion comprises coding the second portion to determine second coded data having a second resolution for the second region based on the second binning pattern; and the second resolution is lower than the first resolution.

In a sixteenth aspect, in combination with one or more of the first aspect through the fifteenth aspect, the operations performed by the at least one processor further include: generating metadata identifying the first binning pattern for the first portion and the second binning pattern for the second portion.

In a seventeenth aspect, in combination with one or more of the first aspect through the sixteenth aspect, coding the first portion comprises encoding the first portion to determine first coded data; coding the second portion comprises encoding the second portion to determine second coded data; and the operations performed by the at least one processor further include transmitting the first coded data and the second coded data through a first interface to an image signal processor.

In an eighteenth aspect, in combination with one or more of the first aspect through the seventeenth aspect, the operations performed by the at least one processor further include: transmitting metadata through the first interface or a second interface to the image signal processor, the metadata comprising a first indication of the first binning pattern for the first coded data and a second indication of the second binning pattern for the second coded data.

In a nineteenth aspect, in combination with one or more of the first aspect through the eighteenth aspect, receiving the image data comprises receiving the image data and the metadata, the metadata comprising a first indication of the first binning pattern for the first portion and a second indication of the second binning pattern for the second portion; coding the first portion comprises decoding the first portion to determine first decoded data based on the first indication; coding the second portion comprises decoding the second portion to determine second decoded data based on the second indication; and the operations performed by the at least one processor further include: determining the image frame by processing the first decoded data and the second decoded data.

In a twentieth aspect, in combination with one or more of the first aspect through the nineteenth aspect, in combination with one or more of the first aspect through the nineteenth aspect, the operations further include coding a third portion of the image data according to a third binning pattern, wherein the third portion corresponds to a third region of the image frame outside the area of interest, and an aspect ratio of the third binning pattern is different from an aspect ratio of the first binning pattern and an aspect ratio of the second binning pattern.

In a twenty-first aspect, in combination with one or more of the first aspect through the twentieth aspect, decoding the first portion comprises remosaicing a first format of the first decoded data to a second format of the image frame.

In a twenty-second aspect, in combination with one or more of the first aspect through the twenty-first aspect, receiving the image data comprises receiving the image data with metadata comprising a first indication of the first binning pattern for the first portion and a second indication of the second binning pattern for the second portion; coding the first portion comprises decoding the first portion to determine first decoded data based on the first indication; coding the second portion comprises decoding the second portion to determine second decoded data based on the second indication; and the operations performed by the at least one processor further include: transmitting the first decoded data and the second decoded data to a display device.

In a twenty-third aspect, in combination with one or more of the first aspect through the twenty-second aspect, a non-transitory computer-readable medium storing instructions that, when executed by a processor, cause the processor to perform operations comprising: receiving image data comprising at least a portion of an image frame; coding a first portion of the image data according to a first binning pattern; and coding a second portion of the image data according to a second binning pattern different from the first binning pattern.

In a twenty-fourth aspect, in combination with one or more of the first aspect through the twenty-third aspect, coding the first portion comprises encoding the first portion to determine first coded data; coding the second portion comprises encoding the second portion to determine second coded data; and the operations further include one or more operations of: transmitting the first coded data and the second coded data through a first interface to an image signal processor.

In a twenty-fifth aspect, in combination with one or more of the first aspect through the twenty-fourth aspect, the operations further include one or more operations of: transmitting metadata through the first interface or a second interface to the image signal processor, the metadata comprising a first indication of the first binning pattern for the first coded data and a second indication of the second binning pattern for the second coded data.

In a twenty-sixth aspect, in combination with one or more of the first aspect through the twenty-fifth aspect, receiving the image data comprises receiving the image data and the metadata, the metadata comprising a first indication of the first binning pattern for the first portion and a second indication of the second binning pattern for the second portion; coding the first portion comprises decoding the first portion to determine first decoded data based on the first indication; coding the second portion comprises decoding the second portion to determine second decoded data based on the second indication; and the operations further include one or more operations of: determining the image frame by processing the first decoded data and the second decoded data.

In a twenty-seventh aspect, in combination with one or more of the first aspect through the twenty-sixth aspect, decoding the first portion comprises remosaicing a first format of the first decoded data to a second format of the image frame.

In a twenty-eighth aspect, in combination with one or more of the first aspect through the twenty-fifth aspect, the apparatus includes an image sensor comprising a binning module to output image data comprising at least a portion of an image frame and to output metadata indicating a first binning size for a first portion of the image data and a second binning size for a second portion of the image data; a memory storing processor-readable code; and at least one processor coupled to the memory and to the image sensor, the at least one processor configured to execute the processor-readable code to cause the at least one processor to perform operations comprising: receiving, from the image sensor over a data bus, the image data and the metadata; decoding the first portion to determine first decoded data based on the first binning size; decoding the second portion to determine second decoded data based on the second binning size; and determining the image frame by processing the first decoded data and the second decoded data.

In a twenty-ninth aspect, in combination with one or more of the first aspect through the twenty-sixth aspect, decoding the first portion comprises remosaicing a first format of the first decoded data to a second format of the image frame.

In a thirtieth aspect, in combination with one or more of the first aspect through the twenty-ninth aspect, the first portion corresponds to a first region in an area of interest of the image frame, and wherein the second portion corresponds to a second region of the image frame outside the area of interest.

In a thirty-first aspect, in combination with one or more of the first aspect through the thirtieth aspect, the binning module identifies the area of interest based on a comparison between a first pixel intensity of image regions located within the area of interest and a second pixel intensity of image regions located outside the area of interest.

In a thirty-second aspect, in combination with one or more of the first aspect through the thirty-first aspect, the first decoded data for the first region has a first resolution based on the first binning pattern; the second decoded data for the second region has a second resolution based on the second binning pattern; and the second resolution is lower than the first resolution.

In a thirty-third aspect, in combination with one or more of the first aspect through the thirty-second aspect, the operations further include coding a third portion of the image data according to a third binning pattern, wherein the third portion corresponds to a third region of the image frame outside the area of interest, and an aspect ratio of the third binning pattern is different from an aspect ratio of the first binning pattern and an aspect ratio of the second binning pattern.

In the figures, a single block may be described as performing a function or functions. The function or functions performed by that block may be performed in a single component or across multiple components, and/or may be performed using hardware, software, or a combination of hardware and software. To clearly illustrate this interchangeability of hardware and software, various illustrative components, blocks, modules, circuits, and steps are described below generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Also, the example devices may include components other than those shown, including well-known components such as a processor, memory, and the like.

Aspects of the present disclosure are applicable to any electronic device including, coupled to, or otherwise processing data from one, two, or more image sensors capable of capturing image frames (or “frames”). The terms “output image frame,” “modified image frame,” and “corrected image frame” may refer to an image frame that has been processed by any of the disclosed techniques to adjust raw image data received from an image sensor. Further, aspects of the disclosed techniques may be implemented for processing image data received from image sensors of the same or different capabilities and characteristics (such as resolution, shutter speed, or sensor type). Further, aspects of the disclosed techniques may be implemented in devices for processing image data, whether or not the device includes or is coupled to image sensors. For example, the disclosed techniques may include operations performed by processing devices in a cloud computing system that retrieve image data for processing that was previously recorded by a separate device having image sensors.

Unless specifically stated otherwise as apparent from the following discussions, it is appreciated that throughout the present application, discussions using terms such as “accessing,” “receiving,” “sending,” “using,” “selecting,” “determining,” “normalizing,” “multiplying,” “averaging,” “monitoring,” “comparing,” “applying,” “updating,” “measuring,” “deriving,” “settling,” “generating,” or the like, refer to the actions and processes of a computer system, or similar electronic computing device, that manipulates and transforms data represented as physical (electronic) quantities within the computer system's registers and memories into other data similarly represented as physical quantities within the computer system's registers, memories, or other such information storage, transmission, or display devices. The use of different terms referring to actions or processes of a computer system does not necessarily indicate different operations. For example, “determining” data may refer to “generating” data. As another example, “determining” data may refer to “retrieving” data.

The terms “device” and “apparatus” are not limited to one or a specific number of physical objects (such as one smartphone, one camera controller, one processing system, and so on). As used herein, a device may be any electronic device with one or more parts that may implement at least some portions of the disclosure. While the description and examples herein use the term “device” to describe various aspects of the disclosure, the term “device” is not limited to a specific configuration, type, or number of objects. As used herein, an apparatus may include a device or a portion of the device for performing the described operations.

Certain components in a device or apparatus described as “means for accessing,” “means for receiving,” “means for sending,” “means for using,” “means for selecting,” “means for determining,” “means for normalizing,” “means for multiplying,” or other similarly-named terms referring to one or more operations on data, such as image data, may refer to processing circuitry (e.g., application specific integrated circuits (ASICs), digital signal processors (DSP), graphics processing unit (GPU), central processing unit (CPU), computer vision processor (CVP), or neural signal processor (NSP)) configured to perform the recited function through hardware, software, or a combination of hardware configured by software.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Components, the functional blocks, and the modules described herein with respect to the Figures referenced above include processors, electronics devices, hardware devices, electronics components, logical circuits, memories, software codes, firmware codes, among other examples, or any combination thereof. Software shall be construed broadly to mean instructions, instruction sets, code, code segments, program code, programs, subprograms, software modules, application, software applications, software packages, routines, subroutines, objects, executables, threads of execution, procedures, and/or functions, among other examples, whether referred to as software, firmware, middleware, microcode, hardware description language or otherwise. In addition, features discussed herein may be implemented via specialized processor circuitry, via executable instructions, or combinations thereof.

Those of skill in the art that one or more blocks (or operations) described with reference to FIGS. 3 and 7-10 may be combined with one or more blocks (or operations) described with reference to another of the figures. For example, one or more blocks (or operations) of FIG. 3 may be combined with one or more blocks (or operations) of FIG. 1 or 2A-2C. As another example, one or more blocks associated with any of FIGS. 7-10 may be combined with one or more blocks (or operations) associated with FIG. 1 or 2A-2C.

Those of skill in the art would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Skilled artisans will also readily recognize that the order or combination of components, methods, or interactions that are described herein are merely examples and that the components, methods, or interactions of the various aspects of the present disclosure may be combined or performed in ways other than those illustrated and described herein.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits, and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, or, any conventional processor, controller, microcontroller, or state machine. In some implementations, a processor may be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also may be implemented as one or more computer programs, which is one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that may be enabled to transfer a computer program from one place to another. A storage media may be any available media that may be accessed by a computer. By way of example, and not limitation, such computer-readable media may include random-access memory (RAM), read-only memory (ROM), electrically erasable programmable read-only memory (EEPROM), CD-ROM or other optical disk storage, magnetic disk storage or other magnetic storage devices, or any other medium that may be used to store desired program code in the form of instructions or data structures and that may be accessed by a computer. Also, any connection may be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to some other implementations without departing from the spirit or scope of this disclosure. Thus, the claims are not intended to be limited to the implementations shown herein but are to be accorded the widest scope consistent with this disclosure, the principles and the novel features disclosed herein.

Additionally, a person having ordinary skill in the art will readily appreciate, opposing terms such as “upper” and “lower,” or “front” and back,” or “top” and “bottom,” or “forward” and “backward” are sometimes used for ease of describing the figures, and indicate relative positions corresponding to the orientation of the figure on a properly oriented page, and may not reflect the proper orientation of any device as implemented.

Certain features that are described in this specification in the context of separate implementations also may be implemented in combination in a single implementation. Conversely, various features that are described in the context of a single implementation also may be implemented in multiple implementations separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown, or in sequential order, or that all illustrated operations be performed to achieve desirable results. Further, the drawings may schematically depict one or more example processes in the form of a flow diagram. However, other operations that are not depicted may be incorporated in the example processes that are schematically illustrated. For example, one or more additional operations may be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products. Additionally, some other implementations are within the scope of the following claims. In some cases, the actions recited in the claims may be performed in a different order and still achieve desirable results.

As used herein, including in the claims, the term “or,” when used in a list of two or more items, means that any one of the listed items may be employed by itself, or any combination of two or more of the listed items may be employed. For example, if a composition is described as containing components A, B, or C, the composition may contain A alone; B alone; C alone; A and B in combination; A and C in combination; B and C in combination; or A, B, and C in combination. Also, as used herein, including in the claims, “or” as used in a list of items prefaced by “at least one of” indicates a disjunctive list such that, for example, a list of “at least one of A, B, or C” means A or B or C or AB or AC or BC or ABC (that is A and B and C) or any of these in any combination thereof.

The term “substantially” is defined as largely, but not necessarily wholly, what is specified (and includes what is specified; for example, substantially 90 degrees includes 90 degrees and substantially parallel includes parallel), as understood by a person of ordinary skill in the art. In any disclosed implementations, the term “substantially” may be substituted with “within [a percentage] of” what is specified, where the percentage includes 0.1, 1, 5, or 10 percent.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

What is claimed is:

1. A method comprising:
receiving image data comprising at least a portion of an image frame;
coding a first portion of the image data according to a first binning pattern; and
coding a second portion of the image data according to a second binning pattern different from the first binning pattern.

2. The method of claim 1, wherein the first portion corresponds to a first region in an area of interest of the image frame, and wherein the second portion corresponds to a second region of the image frame outside the area of interest.

3. The method of claim 2, wherein the method further comprises:
identifying the area of interest based on a comparison between a first pixel intensity of image regions located within the area of interest and a second pixel intensity of image regions located outside the area of interest.

4. The method of claim 2, wherein:
coding the first portion comprises coding the first portion to determine first coded data having a first resolution for the first region based on the first binning pattern;
coding the second portion comprises coding the second portion to determine second coded data having a second resolution for the second region based on the second binning pattern; and
the second resolution is lower than the first resolution.

5. The method of claim 1, further comprising:
generating metadata identifying the first binning pattern for the first portion and the second binning pattern for the second portion.

6. The method of claim 1, wherein:
coding the first portion comprises encoding, by an image sensor, the first portion to determine first coded data;
coding the second portion comprises encoding, by the image sensor, the second portion to determine second coded data; and
the method further comprises:
transmitting the first coded data and the second coded data through a first interface to an image signal processor.

7. The method of claim 6, further comprising:
transmitting metadata through the first interface or a second interface to the image signal processor, the metadata comprising a first indication of the first binning pattern for the first coded data and a second indication of the second binning pattern for the second coded data.

8. The method of claim 1, wherein:
receiving the image data comprises receiving, by an image signal processor, the image data and metadata, the metadata comprising a first indication of the first binning pattern for the first portion and a second indication of the second binning pattern for the second portion;
coding the first portion comprises decoding, by the image signal processor, the first portion to determine first decoded data based on the first indication;
coding the second portion comprises decoding, by the image signal processor, the second portion to determine second decoded data based on the second indication; and
the method further comprises:
determining, by the image signal processor, the image frame by processing the first decoded data and the second decoded data.

9. The method of claim 8, wherein decoding the first portion comprises remosaicing a first format of the first decoded data to a second format of the image frame.

10. The method of claim 1, wherein:
coding the first portion comprises decoding, by a display processor, the first portion to determine first decoded data;
coding the second portion comprises decoding, by the display processor, the second portion to determine second decoded data; and
the method further comprises:
transmitting, by the display processor, the first decoded data and the second decoded data to a display device.

11. An apparatus, comprising:
a memory storing processor-readable code; and
at least one processor coupled to the memory, the at least one processor configured to execute the processor-readable code to cause the at least one processor to perform operations including:
receiving image data comprising at least a portion of an image frame;
coding a first portion of the image data according to a first binning pattern; and
coding a second portion of the image data according to a second binning pattern different from the first binning pattern.

12. The apparatus of claim 11, wherein the first portion corresponds to a first region in an area of interest of the image frame, and wherein the second portion corresponds to a second region of the image frame outside the area of interest.

13. The apparatus of claim 12, wherein the operations performed by the at least one processor further include:
identifying the area of interest based on a comparison between a first pixel intensity of image regions located within the area of interest and a second pixel intensity of image regions located outside the area of interest.

14. The apparatus of claim 12, wherein:
coding the first portion comprises coding the first portion to determine first coded data having a first resolution for the first region based on the first binning pattern;
coding the second portion comprises coding the second portion to determine second coded data having a second resolution for the second region based on the second binning pattern; and
the second resolution is lower than the first resolution.

15. The apparatus of claim 11, wherein the operations performed by the at least one processor further include:
generating metadata identifying the first binning pattern for the first portion and the second binning pattern for the second portion.

16. The apparatus of claim 11, wherein:
coding the first portion comprises encoding the first portion to determine first coded data;
coding the second portion comprises encoding the second portion to determine second coded data; and
the operations performed by the at least one processor further include:
transmitting the first coded data and the second coded data through a first interface to an image signal processor.

17. The apparatus of claim 16, wherein the operations performed by the at least one processor further include:
transmitting metadata through the first interface or a second interface to the image signal processor, the metadata comprising a first indication of the first binning pattern for the first coded data and a second indication of the second binning pattern for the second coded data.

18. The apparatus of claim 11, wherein:
receiving the image data comprises receiving the image data and metadata, the metadata comprising a first indication of the first binning pattern for the first portion and a second indication of the second binning pattern for the second portion;
coding the first portion comprises decoding the first portion to determine first decoded data based on the first indication;
coding the second portion comprises decoding the second portion to determine second decoded data based on the second indication; and
the operations performed by the at least one processor further include:
determining the image frame by processing the first decoded data and the second decoded data.

19. The apparatus of claim 18, wherein decoding the first portion comprises remosaicing a first format of the first decoded data to a second format of the image frame.

20. The apparatus of claim 11, wherein:
receiving the image data comprises receiving the image data with metadata comprising a first indication of the first binning pattern for the first portion and a second indication of the second binning pattern for the second portion;
coding the first portion comprises decoding the first portion to determine first decoded data based on the first indication;
coding the second portion comprises decoding the second portion to determine second decoded data based on the second indication; and
the operations performed by the at least one processor further include:
transmitting the first decoded data and the second decoded data to a display device.

21. A non-transitory computer-readable medium storing instructions that, when executed by a processor, cause the processor to perform operations comprising:
receiving image data comprising at least a portion of an image frame;
coding a first portion of the image data according to a first binning pattern; and
coding a second portion of the image data according to a second binning pattern different from the first binning pattern.

22. The non-transitory, computer-readable medium of claim 21, wherein:
coding the first portion comprises encoding the first portion to determine first coded data;
coding the second portion comprises encoding the second portion to determine second coded data; and
the operations further include one or more operations of:
transmitting the first coded data and the second coded data through a first interface to an image signal processor.

23. The non-transitory, computer-readable medium of claim 22, wherein the operations further include one or more operations of:
transmitting metadata through the first interface or a second interface to the image signal processor, the metadata comprising a first indication of the first binning pattern for the first coded data and a second indication of the second binning pattern for the second coded data.

24. The non-transitory, computer-readable medium of claim 21, wherein:
receiving the image data comprises receiving the image data and metadata, the metadata comprising a first indication of the first binning pattern for the first portion and a second indication of the second binning pattern for the second portion;
coding the first portion comprises decoding the first portion to determine first decoded data based on the first indication;
coding the second portion comprises decoding the second portion to determine second decoded data based on the second indication; and
the operations further include one or more operations of:
determining the image frame by processing the first decoded data and the second decoded data.

25. The non-transitory, computer-readable medium of claim 24, wherein decoding the first portion comprises remosaicing a first format of the first decoded data to a second format of the image frame.

26. An image capture device comprising:
an image sensor comprising a binning module to output image data comprising at least a portion of an image frame and to output metadata indicating a first binning pattern for a first portion of the image data and a second binning pattern for a second portion of the image data;
a memory storing processor-readable code; and
at least one processor coupled to the memory and to the image sensor, the at least one processor configured to execute the processor-readable code to cause the at least one processor to perform operations comprising:
receiving, from the image sensor over a data bus, the image data and the metadata;
decoding the first portion to determine first decoded data based on the first binning pattern;
decoding the second portion to determine second decoded data based on the second binning pattern; and
determining the image frame by processing the first decoded data and the second decoded data.

27. The image capture device of claim 26, wherein decoding the first portion comprises remosaicing a first format of the first decoded data to a second format of the image frame.

28. The image capture device of claim 26, wherein the first portion corresponds to a first region in an area of interest of the image frame, and wherein the second portion corresponds to a second region of the image frame outside the area of interest.

29. The image capture device of claim 28, wherein the binning module identifies the area of interest based on a comparison between a first pixel intensity of image regions located within the area of interest and a second pixel intensity of image regions located outside the area of interest.

30. The image capture device of claim 28, wherein:
the first decoded data for the first region has a first resolution based on the first binning pattern;
the second decoded data for the second region has a second resolution based on the second binning pattern; and
the second resolution is lower than the first resolution.
